(19) United States
(12) Patent Application Publication
(10) Pub. No.: US 2023/0335733 A1
(43) Pub. Date: Oct. 19, 2023

(54) SECONDARY BATTERY AND METHOD FOR MANUFACTURING SECONDARY BATTERY

(71) Applicant: SEMICONDUCTOR ENERGY LABORATORY CO., LTD., Atsugi-shi (JP)

(72) Inventors: Mayumi MIKAMI, Atsugi (JP); Yohei MOMMA, Isehara (JP); Kazutaka KURIKI, Ebina (JP); Kazuhei NARITA, Atsugi (JP)

(21) Appl. No.: 18/138,790

(22) Filed: Apr. 25, 2023

Related U.S. Application Data
(63) Continuation of application No. 16/761,504, filed on May 5, 2020, now abandoned.

(30) Foreign Application Priority Data
Nov. 24, 2017 (JP) 2017-225386

(51) Int. Cl. H01M 4/58; H01M 10/0525; H01M 10/0562; H01M 50/446

(52) U.S. Cl. CPC H01M 4/582; H01M 10/0525; H01M 10/0562; H01M 50/446; H01M 2004/028

(57) ABSTRACT

A conduction path in an all-solid-state secondary battery is difficult to keep with a volume change in an active material due to charging and discharging in some cases. A positive electrode active material with a small volume change between the charged state and the discharged state is used for an all-solid-state secondary battery. For example, a positive electrode active material that has a layered rock-salt crystal structure in the discharged state and a crystal structure similar to the cadmium chloride type crystal structure in the charged state with a depth of charge of approximately 0.8 changes less in its volume and crystal structure between charging and discharging than known positive electrode active materials.

### CROSS-REFERENCE TO RELATED APPLICATIONS

This application is a continuation of U.S. application Ser. No. 16/761,504, filed May 5, 2020, now pending, which is incorporated by reference and is a U.S. National Phase Application under 35 U.S.C. § 371 of International Application PCT/IB2018/059020, filed on Nov. 16, 2018, which is incorporated by reference and claims the benefit of a foreign priority application filed in Japan on Nov. 24, 2017, as Application No. 2017-225386.

### TECHNICAL FIELD

The present invention relates to an object, a method, or a manufacturing method. Alternatively, the present invention relates to a process, a machine, manufacture, or a composition (a composition of matter). One embodiment of the present invention relates to a semiconductor device, a display device, a light-emitting device, a power storage device, a lighting device, an electronic device, or a manufacturing method thereof. In particular, one embodiment of the present invention relates to a positive electrode active material that can be used for a secondary battery, a secondary battery, and an electronic device including a secondary battery.

Note that in this specification, power storage devices mean all elements and devices having a function of storing power. Examples of the power storage devices include a storage battery (also referred to as a secondary battery) such as a lithium-ion secondary battery, a lithium-ion capacitor, and an electric double layer capacitor.

In addition, electronic devices in this specification mean all devices including power storage devices, and electro-optical devices including power storage devices, information terminal devices including power storage devices, and the like are all electronic devices.

### BACKGROUND ART

In recent years, a variety of power storage devices such as lithium-ion secondary batteries, lithium-ion capacitors, and air batteries have been actively developed. In particular, demand for lithium-ion secondary batteries with high output and high energy density has rapidly grown with the development of the semiconductor industry, for portable information terminals such as mobile phones, smartphones, tablets, and laptop computers; portable music players; digital cameras; medical equipment; next-generation clean energy vehicles such as hybrid electric vehicles (HEV), electric vehicles (EV), and plug-in hybrid electric vehicles (PHEV); and the like. The lithium-ion secondary batteries are essential as rechargeable energy supply sources for today's information society.

In particular, an all-solid-state lithium-ion secondary battery that uses a solid electrolyte instead of a combination of an organic electrolyte solution and a lithium salt has attracted attention. An all-solid-state lithium-ion secondary battery uses a non-flammable solid-state electrolyte instead of a flammable organic electrolyte solution, and thus has a high level of safety. Furthermore, it has an advantage that its energy density and size are easily increased.

For this reason, the solid electrolyte has been actively studied, aiming at practical use of all-solid-state lithium-ion secondary batteries (Patent Document 1 to Patent Document 3).

In addition, a crystal structure of lithium cobalt oxide, which is widely used as a positive electrode active material of a secondary battery without limitation to the all-solid-state battery, has been studied in detail (Non-Patent Document 1 to Non-Patent Document 3).

### REFERENCES

### Patent Documents

[Patent Document 1] Japanese Published Patent Application No. 2010-272344
[Patent Document 2] Japanese Published Patent Application No. 2011-233246
[Patent Document 3] Japanese Published Patent Application No. 2008-226463

### Non-Patent Documents

[Non-Patent Document 1] Toyoki Okumura et al., “Correlation of lithium ion distribution and X-ray absorption near-edge structure in O3- and O2-lithium cobalt oxides from first-principle calculation”, Journal of Materials Chemistry, 2012, 22, pp. 17340-17348.
[Non-Patent Document 2] Motohashi, T. et al., “Electronic phase diagram of the layered cobalt oxide system LiₓCoO₂ (0.0≤x≤1.0)”, Physical Review B, 80 (16); 165114.
[Non-Patent Document 3] Zhaohui Chen et al., “Staging Phase Transitions in LiₓCoO₂, Journal of The Electrochemical Society, 2002, 149 (12) A1604-A1609.

### SUMMARY OF THE INVENTION

### Problems to be Solved by the Invention

One of the problems of the all-solid-state secondary battery is that a conduction path of lithium ions is difficult to keep with a volume change in an active material due to charging and discharging.

In a secondary battery using a conventional organic electrolyte solution, the electrolyte solution enters a space in an active material layer, which forms a conduction path of lithium ions. Thus, owing to the electrolyte solution which is a liquid, the conduction path of lithium ions can be kept without any problem even when the value of the active material changes and the size of the space accordingly changes.

However, in an all-solid-state secondary battery, part of an active material cannot have physical contact with a solid electrolyte due to an increase in the size of a space accompanying the volume change in the active material in some cases; thus, a conduction path of lithium ions is difficult to keep. Therefore, capacity is likely to noticeably decrease in accordance with an increase in the number of repeated charging and discharging.

In view of the above, an object of one embodiment of the present invention is to provide an all-solid-state lithium-ion secondary battery in which a decrease in capacity in charge and discharge cycles is inhibited. Another object is to provide an all-solid-state lithium-ion secondary battery with high capacity and excellent safety, and a manufacturing method thereof. Another object is to provide a manufacturing method of an all-solid-state lithium-ion secondary battery with high productivity. Another object is to provide an all-solid-state lithium-ion secondary battery with high capacity. Another object is to provide an all-solid-state lithium-ion secondary battery with a high level of safety or high reliability.

Another object of one embodiment of the present invention is to provide a novel material, active material, or storage device, or a manufacturing method thereof.

Note that the description of these objects does not disturb the existence of other objects. One embodiment of the present invention does not have to achieve all the objects. Note that other objects can be derived from the description of the specification, the drawings, and the claims.

### Means for Solving the Problems

In order to achieve the above objects, a secondary battery of one embodiment of the present invention is characterized in that a positive electrode active material with a small volume change between the charged state and the discharged state is used. For example, a positive electrode active material that has a layered rock-salt crystal structure in the discharged state and a crystal structure similar to the CdCl₂-type crystal structure in the charged state with a depth of charge of approximately 0.8, specifically greater than or equal to 0.77 and less than or equal to 0.84 changes less in its volume and crystal structure between charging and discharging than known positive electrode active materials.

One embodiment of the present invention is a secondary battery including a positive electrode, a negative electrode, and a solid electrolyte layer between the positive electrode and the negative electrode; the positive electrode has a crystal structure similar to the CdCl₂-type crystal structure.

Another embodiment of the present invention is a secondary battery including a positive electrode, a negative electrode, a solid electrolyte layer between the positive electrode and the negative electrode; when the positive electrode is analyzed by powder X-ray diffraction using a CuKα1 ray in a state where a depth of charge of the secondary battery is greater than or equal to 0.77 and less than or equal to 0.84, the secondary battery has diffraction peaks at θ=19.30±0.20° and 2θ=45.55±0.10°.

In the above, the solid electrolyte layer preferably includes an oxide-based solid electrolyte.

In the above, the oxide-based solid electrolyte preferably has a NASICON crystal structure.

### Effect of the Invention

One embodiment of the present invention can provide an all-solid-state lithium-ion secondary battery in which a decrease in capacity in charge and discharge cycles is inhibited. Alternatively, an all-solid-state lithium-ion secondary battery with high capacity and excellent safety, and a manufacturing method thereof can be provided. Alternatively, a manufacturing method of an all-solid-state lithium-ion secondary battery with high productivity can be provided. Alternatively, an all-solid-state lithium-ion secondary battery with high capacity can be provided. Alternatively, an all-solid-state lithium-ion secondary battery with a high level of safety or high reliability can be provided. Alternatively, one embodiment of the present invention can provide a novel material, active material, or power storage device, or a manufacturing method thereof.

### BRIEF DESCRIPTION OF THE DRAWINGS

FIG. 1 A diagram illustrating the depth of charge and crystal structures of a positive electrode active material of one embodiment of the present invention.

FIG. 2 A diagram illustrating the depth of charge and crystal structures of a conventional positive electrode active material.

FIG. 3 XRD patterns calculated from crystal structures.

FIGS. 4A to 4B Diagrams illustrating a crystal structure and magnetism of a positive electrode active material used for a secondary battery of one embodiment of the present invention.

FIGS. 5A to 5B Diagrams illustrating a crystal structure and magnetism of a conventional positive electrode active material.

FIG. 6 A diagram illustrating an example of a method for forming a positive electrode active material used for a secondary battery of one embodiment of the present invention.

FIG. 7 A diagram illustrating another example of a method for forming a positive electrode active material used for a secondary battery of one embodiment of the present invention.

FIGS. 8A to 8B Diagrams illustrating examples of a secondary battery of one embodiment of the present invention.

FIGS. 9A to 9B Diagrams illustrating an example of a secondary battery of one embodiment of the present invention.

FIG. 10 A diagram illustrating an example of a method for forming a solid electrolyte used for a secondary battery of one embodiment of the present invention.

FIGS. 11A to 11C Diagrams illustrating an example of a secondary battery of one embodiment of the present invention.

FIGS. 12A to 12B Diagrams illustrating an example of a secondary battery of one embodiment of the present invention.

FIGS. 13A to 13D Diagrams illustrating an example of a secondary battery of one embodiment of the present invention and a manufacturing method thereof.

FIGS. 14A to 14B Diagrams illustrating an example of a secondary battery of one embodiment of the present invention and a manufacturing method thereof.

FIGS. 15A to 15E Diagrams illustrating examples of small electronic devices and vehicles each including a secondary battery of one embodiment of the present invention.

FIG. 16A to 16C Diagrams illustrating examples of a vehicle and a house each including a secondary battery of one embodiment of the present invention.

### MODE FOR CARRYING OUT THE INVENTION

Hereinafter, embodiments of the present invention will be described in detail using the drawings. Note that the present invention is not limited to the description below, and it is easily understood by those skilled in the art that modes and details thereof can be modified in various ways. In addition, the present invention should not be construed as being limited to the description in the following embodiments.

In addition, in this specification and the like, crystal planes and orientations are indicated by the Miller indices. In the crystallography, a bar is placed over a number in the expression of crystal planes and orientations; however, in this specification and the like, crystal planes and orientations are in some cases expressed by placing − (a minus sign)□ before a number instead of placing a bar over the number because of patent expression limitations. Furthermore, an individual direction that shows an orientation in a crystal is denoted by “[ ]”, a set direction that shows all of the equivalent orientations is denoted by “< >”, an individual plane that shows a crystal plane is denoted by “( )”, and a set plane having equivalent symmetry is denoted by “{ }”. Furthermore, 1 Å is 10⁻¹⁰ m.

In this specification and the like, a surface portion of a particle of an active material or the like refers to a region from a surface to a depth of approximately 10 nm. A plane generated by a crack may also be referred to as a surface. In addition, a region which is located at a deeper portion than the surface portion is referred to as an inner portion.

In this specification and the like, a layered rock-salt crystal structure of a composite oxide containing lithium and a transition metal refers to a crystal structure which has rock-salt ion arrangement where cations and anions are alternately arranged and in which lithium can be two-dimensionally diffused owing to a formation of two-dimensional plane by regular arrangement of the transition metal and lithium. Note that a defect such as a cation or anion vacancy may exist. Moreover, strictly speaking, a lattice of a rock-salt crystal is distorted in the layered rock-salt crystal structure in some cases.

In addition, in this specification and the like, a rock-salt crystal structure refers to a structure in which cations and anions are alternately arranged. Note that a cation or anion vacancy may exist.

In this specification and the like, a crystal structure similar to the CdCl₂-type crystal structure refers to a crystal structure that belongs to the space group R-3m; in an example of the case of including cobalt as the transition metal, cobalt is oxygen-hexacoordinated, cobalt forms two-dimensional triangle lattice, and Li is included between CoO₂ layers randomly. In the crystal structure similar to the CdCl₂-type crystal structure, oxygen forms a cubic close-packed structure, and three types of oxygen layers are repeatedly stacked, like ABCABC. The crystal structure similar to the CdCl₂-type crystal structure is close to a crystal structure of lithium nickel oxide that is charged to a depth of charge of 0.94 (Li_{0.06}NiO₂); however, pure lithium cobalt oxide or a layered rock-salt positive electrode active material containing a large amount of cobalt is known not to have this crystal structure generally.

In the crystal structure similar to the CdCl₂-type crystal structure, the cation arrangement has symmetry similar to that in the spinel crystal structure; thus, the crystal structure similar to the CdCl₂-type crystal structure can be said to be a pseudo-spinel crystal structure.

In the layered rock-salt crystal, the rock-salt crystal, and the crystal structure similar to the CdCl₂-type crystal structure, the anion arrangement is a cubic close-packed structure (a face-centered cubic lattice structure). When these are in contact with each other, there is a crystal plane at which orientations of cubic close-packed structures composed of anions are aligned. Note that the space groups of the layered rock-salt crystal and the crystal similar to the CdCl₂-type crystal are R-3m, which is different from the space groups of the rock-salt crystal, Fm-3m (the space group of a general rock-salt crystal) and Fd-3m (the space group of a rock-salt crystal having the simplest symmetry); thus, the Miller indices of the crystal plane satisfying the above conditions in the layered rock-salt crystal and the crystal similar to the CdCl₂-type crystal are different from that in the rock-salt crystal. In this specification, a state where the orientations of the cubic close-packed structures composed of anions in the layered rock-salt crystal, the crystal similar to the CdCl₂-type crystal, and the rock-salt crystal are aligned is sometimes referred to as a state where crystal orientations are substantially aligned.

Whether the crystal orientations in two regions are substantially aligned can be judged from a TEM (transmission electron microscope) image, a STEM (scanning transmission electron microscope) image, a HAADF-STEM (high-angle annular dark-field scanning transmission electron microscope) image, an ABF-STEM (annular bright-field scanning transmission electron microscope) image, and the like. X-ray diffraction (XRD), electron diffraction, neutron diffraction, and the like can also be used for judging. In the TEM image and the like, alignment of cations and anions can be observed as repetition of bright lines and dark lines. When the orientations of cubic close-packed structures in the layered rock-salt crystal and the rock-salt crystal are aligned, a state where an angle made by the repetition of bright lines and dark lines in the crystals is less than or equal to 5°, further preferably less than or equal to 2.5° can be observed. Note that in the TEM image and the like, a light element such as oxygen or fluorine cannot be clearly observed in some cases; however, in such a case, alignment of orientations can be judged by arrangement of metal elements.

In addition, in this specification and the like, theoretical capacity of a positive electrode active material refers to the amount of electricity obtained when all lithium that can be inserted and extracted and is contained in the positive electrode active material is extracted. For example, the theoretical capacity of LiCoO₂ is 274 mAh/g, the theoretical capacity of LiNiO₂ is 274 mAh/g, and the theoretical capacity of LiMn₂O₄ is 148 mAh/g.

In addition, in this specification and the like, depth of charge obtained when all lithium that can be inserted and extracted is inserted is 0, and depth of charge obtained when all lithium that can be inserted and extracted and is contained in a positive electrode active material is extracted is 1.

In addition, in this specification and the like, charging refers to transfer of lithium ions from a positive electrode to a negative electrode in a battery and transfer of electrons from the negative electrode to the positive electrode in an external circuit. For a positive electrode active material, extraction of lithium ions is called charging. Moreover, a positive electrode active material with a depth of charge of greater than or equal to 0.74 and less than or equal to 0.9, more specifically, a depth of charge of greater than or equal to 0.77 and less than or equal to 0.84 is referred to as a high-voltage charged positive electrode active material. For example, LiCoO₂ charged to greater than or equal to 212 mAh/g is a high-voltage charged positive electrode active material. In addition, LiCoO₂ that is subjected to constant current charging in an environment at 25° C. and a charging voltage of higher than or equal to 4.55 V and lower than or equal to 4.63 V (in the case of a lithium counter electrode), and then subjected to constant voltage charging until the current value becomes 0.01 C is also referred to as a high-voltage charged positive electrode active material.

Similarly, discharging refers to transfer of lithium ions from a negative electrode to a positive electrode in a battery and transfer of electrons from the positive electrode to the negative electrode in an external circuit. For a positive electrode active material, insertion of lithium ions is called discharging. Furthermore, a positive electrode active material with a depth of charge of less than or equal to 0.06 or a positive electrode active material from which more than or equal to 90% of the charge capacity is discharged from a state where the positive electrode active material is charged with high voltage is referred to as a sufficiently discharged positive electrode active material. For example, LiCoO₂ with a charge capacity of 212 mAh/g or more is in a state of being charged with high voltage, and a positive electrode active material from which more than or equal to 190.8 mAh/g, which is 90% of the charge capacity, is discharged is a sufficiently discharged positive electrode active material. In addition, LiCoO₂ that is subjected to constant current discharging in an environment at 25° C. until the battery voltage becomes lower than or equal to 3 V (in the case of a lithium counter electrode) is also referred to as a sufficiently discharged positive electrode active material.

In addition, in this specification and the like, an unbalanced phase change refers to a phenomenon that causes a nonlinear change in physical quantity. For example, an unbalanced phase change might occur before and after peaks in a dQ/dV curve obtained by differentiating capacitance (Q) with voltage (V) (dQ/dV), which can largely change the crystal structure.

### Embodiment 1

In this embodiment, a positive electrode active material 111 that can be used for a secondary battery 100 of one embodiment of the present invention will be described.

### [Structure of Positive Electrode Active Material]

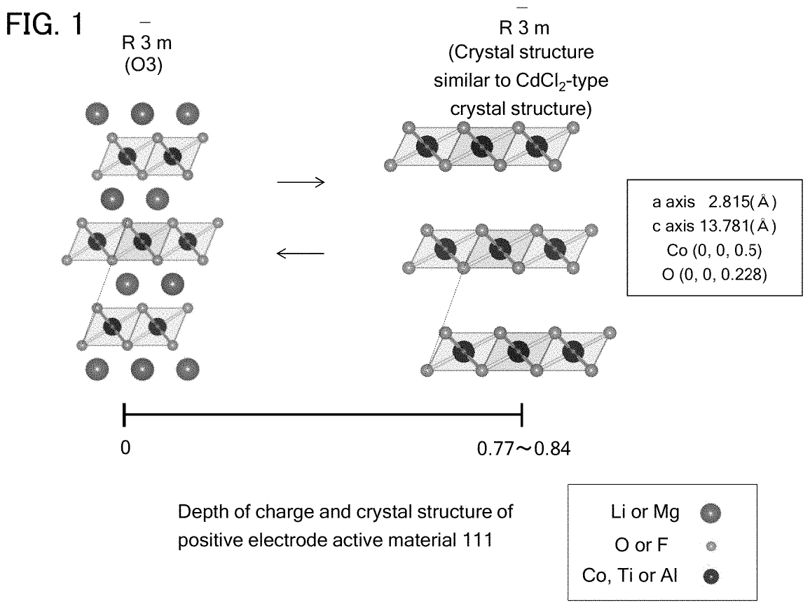

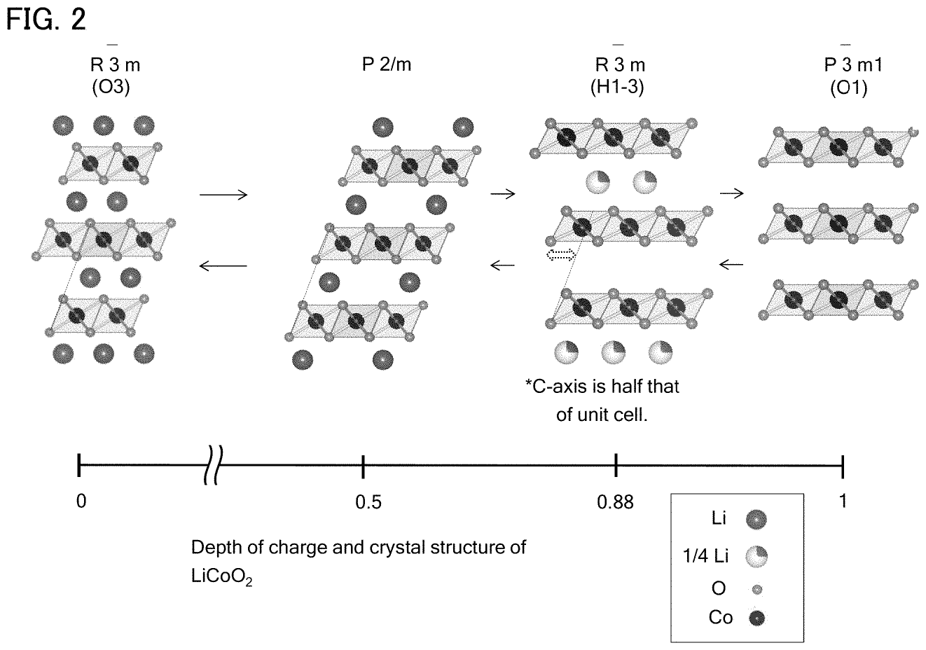

First, the positive electrode active material 111 used for the secondary battery 100 of one embodiment of the present invention and a conventional positive electrode active material are described with reference to FIG. 1 and FIG. 2, and a difference therebetween is described. The conventional positive electrode active material here is simple lithium cobalt oxide (LiCoO₂) in which an element other than lithium, cobalt, and oxygen is neither added to an inner portion nor applied to a surface portion, for example.

### <Conventional Positive Electrode Active Material>

As described in Non-Patent Document 1, Non-Patent Document 2, and the like, the crystal structure of lithium cobalt oxide changes depending on the depth of charge. FIG. 2 illustrates typical crystal structures.

As illustrated in FIG. 2, LiCoO₂ with a depth of charge of 0 (in the discharged state) has the crystal structure of the space group R-3m, and includes three CoO₂ layers in a unit cell. This crystal structure is referred to as an O3-type crystal structure in some cases. Note that the CoO₂ layer has a structure in which octahedral geometry with oxygen atoms hexacoordinated to cobalt continues on a plane in the edge-sharing state.

Furthermore, when the depth of charge is 1, lithium cobalt oxide has the crystal structure of the space group P-3m1, and one CoO₂ layer exists in a unit cell. Thus, this crystal structure is referred to as an O1-type crystal structure in some cases.

When the depth of charge is approximately 0.88, lithium cobalt oxide has a crystal structure of the space group R-3m. This structure can also be regarded as a structure in which CoO₂ structures such as P-3m1 (O1) and LiCoO₂ structures such as R-3m(O3) are alternately stacked. Thus, this crystal structure is referred to as an H1-3 type crystal structure in some cases. Note that the number of cobalt atoms per unit cell in the actual H1-3 type crystal structure is twice as large as that of cobalt atoms per unit cell in the other structures. However, in this specification including FIG. 2, the c-axis of the H1-3 type crystal structure is half that of the unit cell for easy comparison with the other crystal structures.

When high-voltage charging with a depth of charge of approximately 0.88 or more and discharging are repeated, the crystal structure of lithium cobalt oxide repeatedly changes between the H1-3 type crystal structure and the R-3m(O3) structure in the discharged state (i.e., an unbalanced phase change).

However, there is a large deviation in the position of the CoO₂ layer between these two crystal structures. As indicated by dotted lines and an arrow in FIG. 2, the CoO₂ layer in the H1-3 type crystal structure largely shifts from that in the R-3m(O3) structure. Such a dynamic structural change might adversely affect the stability of the crystal structure.

A difference in volume is also large. A difference in volume in comparison with the same number of cobalt atoms between the H1-3 type crystal structure and the O3-type crystal structure in the discharged state is 3.5% or more.

In addition, a structure in which CoO₂ layers are arranged in a successive manner, as in P-3m1 (O1), included in the H1-3 type crystal structure is highly likely to be unstable.

Thus, the repeated high-voltage charging and discharging break the crystal structure of lithium cobalt oxide. The break of the crystal structure degrades the cycle performance. This is probably because the break of the crystal structure reduces sites where lithium can stably exist and makes it difficult to insert and extract lithium.

<Positive Electrode Active Material that can be Used for Secondary Battery of One Embodiment of the Present Invention>

### «Inner Portion»

By contrast, in the positive electrode active material 111 of one embodiment of the present invention, there is a small difference in the volume and crystal structure between a sufficiently discharged state and a high-voltage charged state.

FIG. 1 illustrates the crystal structures of the positive electrode active material 111 before and after charging and discharging. The positive electrode active material 111 is a composite oxide containing lithium, cobalt, and oxygen. In addition to the above, magnesium is preferably contained. Furthermore, halogen such as fluorine or chlorine is preferably contained.

The crystal structure with a depth of charge of 0 (in the discharged state) in FIG. 1 belongs to R-3m(O3) as in FIG. 2. However, when the depth of charge is greater than or equal to 0.77 and less than or equal to 0.84, the positive electrode active material 111 of one embodiment of the present invention has a crystal structure different from that in FIG. 2. In this specification and the like, the crystal structure of the space group R-3m is referred to as a crystal structure similar to the CdCl₂-type crystal structure. Note that although the indication of lithium is omitted in the diagram of the crystal structure similar to the CdCl₂-type crystal structure for explaining the symmetry of cobalt atoms and the symmetry of oxygen atoms, lithium practically exists between CoO₂ layers at higher than or equal to 16 atomic % and lower than or equal to 23 atomic % with respect to cobalt. In addition, in both the O3-type crystal structure and the crystal structure similar to the CdCl₂-type crystal structure, magnesium preferably exists between the CoO₂ layers, i.e., in lithium sites, at a slight concentration. In addition, it is preferable that halogen such as fluorine randomly exist in oxygen sites at a slight concentration.

In the positive electrode active material 111, a change in the crystal structure when high-voltage charging is performed and a large amount of lithium is extracted is inhibited as compared with conventional LiCoO₂. As indicated by dotted lines in FIG. 1, for example, there is little difference in the positions of the CoO₂ layers between the crystal structures. That is, the symmetry of the crystal structure is not changed even in a state where a large amount of lithium is extracted.

In addition, in the positive electrode active material 111, a difference in the volume per unit cell between the O3-type crystal structure with a depth of charge of 0 and the crystal structure similar to the CdCl₂-type crystal structure with a depth of charge of 0.88 is less than or equal to 2.5%, more specifically, less than or equal to 2.2%.

Thus, the crystal structure is less likely to be broken by repeated high-voltage charging and discharging. The interface with a solid electrolyte is likely to be maintained because the symmetry of the crystal does not change. Furthermore, owing to a small change in volume, a physical contact with a solid electrolyte is easily maintained in the case of being used for an all-solid-state battery. Thus, a reduction in the capacity of the all-solid-state secondary battery in charge and discharge cycles can be inhibited.

Note that in the unit cell of the crystal structure similar to the CdCl₂-type crystal structure, coordinates of cobalt and oxygen can be represented by Co (0, 0, 0.5) and O (0, 0, x) within the range of 0.20≤x≤0.25.

Magnesium randomly existing between the CoO₂ layers, i.e., in the lithium sites, at a slight concentration has an effect of inhibiting a deviation of the CoO₂ layers. Thus, when magnesium exists between the CoO₂ layers, the crystal structure similar to the CdCl₂-type crystal structure is likely to be formed. Therefore, magnesium is preferably distributed over whole particles of the positive electrode active material 111. In addition, to distribute magnesium over the whole particles, heat treatment is preferably performed in a formation process of the positive electrode active material 111.

However, cation mixing occurs when the heat treatment temperature is excessively high, so that magnesium is highly likely to enter the cobalt sites. Magnesium in the cobalt sites loses the effect of maintaining the R-3m structure. Furthermore, when the heat treatment temperature is excessively high, adverse effects such as reduction of cobalt to have a valence of two and transpiration of lithium are concerned.

In view of the above, a halogen compound such as a fluorine compound is preferably added to lithium cobalt oxide before the heat treatment for distributing magnesium over whole particles. The addition of the halogen compound decreases the melting point of lithium cobalt oxide. The decrease in the melting point makes it easier to distribute magnesium over whole particles at a temperature at which the cation mixing is unlikely to occur.

### «Surface Portion»

Magnesium is preferably distributed over the whole particles of the positive electrode active material 111, and further preferably, the magnesium concentration in the surface portion of the particle is higher than the average in the whole particles. The entire surface of the particle is a kind of crystal defects and lithium is extracted from the surface during charging; thus, the lithium concentration in the surface of the particle tends to be lower than that inside the particle. Therefore, the surface of the particle tends to be unstable and its crystal structure easily starts to change. The higher the magnesium concentration in the surface portion is, the more effectively the change in the crystal structure can be inhibited.

In addition, the concentration of halogen such as fluorine in the surface portion of the positive electrode active material 111 is preferably higher than the average in whole particles.

In this manner, the surface portion of the positive electrode active material 111 preferably has higher concentrations of magnesium and fluorine than the inner portion and a composition different from that in the inner portion. In addition, the composition preferably has a crystal structure stable at normal temperature. Thus, the surface portion may have a crystal structure different from that of the inner portion. For example, at least part of the surface portion of the positive electrode active material 111 may have a rock-salt crystal structure. Furthermore, in the case where the surface portion and the inner portion have different crystal structures, the orientations of crystals in the surface portion and the inner portion are preferably substantially aligned.

Note that in the surface portion where only MgO is contained or MgO and CoO(II) form a solid solution, it is difficult to insert and extract lithium. Thus, the surface portion should contain at least cobalt, and further contain lithium in the discharged state to have a path through which lithium is inserted and extracted. In addition, the cobalt concentration is preferably higher than the magnesium concentration.

Furthermore, the positive electrode active material 111 may include a solid electrolyte in the surface portion. As the solid electrolyte, a sulfide-based solid electrolyte, an oxide-based solid electrolyte, a halide-based solid electrolyte, a combination thereof, or the like can be used. In some cases, a solid electrolyte containing aluminum is preferably used for the surface portion of the positive electrode active material 111 because it is stable even at a high potential.

The positive electrode active material 111 may include a buffer layer, such as lithium niobate, against the solid electrolyte in the surface portion. The buffer layer preferably exists between lithium cobalt oxide and the solid electrolyte.

The positive electrode active material 111 may have a region in which lithium cobalt oxide is mixed with the above solid electrolyte or buffer layer.

### «Grain Boundary»

In addition, the magnesium concentration in the crystal grain boundary of the positive electrode active material 111 and its vicinity is preferably higher than that in the other regions in the inner portion. The halogen concentration in the crystal grain boundary and its vicinity is also preferably high. Furthermore, one of titanium and aluminum may be included in the crystal grain boundary and its vicinity.

Like the particle surface, the crystal grain boundary is also a plane defect. Thus, the crystal grain boundary tends to be unstable and its crystal structure easily starts to change. Therefore, the higher the magnesium concentration in the crystal grain boundary and its vicinity is, the more effectively the change in the crystal structure can be inhibited.

Furthermore, even when cracks are generated along the crystal grain boundary of the particle of the positive electrode active material 111, high concentrations of magnesium and halogen in the crystal grain boundary and its vicinity increase the concentrations of magnesium and halogen in the vicinity of a surface generated by the cracks. Thus, the positive electrode active material after the cracks are generated can also have increased corrosion resistance to hydrofluoric acid.

Note that in this specification and the like, the vicinity of the crystal grain boundary refers to a region of approximately 10 nm from the grain boundary.

### <Analysis Method>

Whether or not a material is the positive electrode active material 111 of one embodiment of the present invention that has the crystal structure similar to the CdCl₂-type crystal structure when charged with high voltage can be determined by analyzing a high-voltage charged positive electrode using XRD, electron diffraction, neutron diffraction, electron spin resonance (ESR), nuclear magnetic resonance (NMR), or the like. The XRD is particularly preferable because the symmetry of a transition metal such as cobalt contained in the positive electrode active material can be analyzed with high resolution and a positive electrode obtained by disassembling a secondary battery can be measured without any change with sufficient accuracy, for example.

As described so far, the positive electrode active material 111 of one embodiment of the present invention has a feature of a small change in the volume and crystal structure between the high-voltage charged state and the discharged state. A material where a crystal structure that largely changes between the high-voltage charged state and the discharged state holds the majority is not preferable because the material cannot withstand the high-voltage charging and discharging. In addition, it should be noted that an objective crystal structure is not obtained in some cases only by addition of impurity elements. For example, in the high voltage charged state, some has the crystal structure similar to the CdCl₂-type crystal structure of 60 wt % or more and some has the H1-3 type crystal structure of the majority although those have the common feature of being a lithium cobalt oxide containing Mg and F. Thus, analysis of the crystal structure, including XRD, is needed to determine whether or not the material is the positive electrode active material 111 of one embodiment of the present invention.

Note that a positive electrode active material in the charged state or the discharged state sometimes causes a change in the crystal structure when exposed to air. For example, the crystal structure similar to the CdCl₂-type crystal structure changes into the H1-3 type crystal structure in some cases. Thus, samples are preferably handled in an inert atmosphere such as an argon atmosphere.

### «Charging Method»

High-voltage charging for determining whether or not a composite oxide is the positive electrode active material 111 that can be used for the secondary battery 100 of one embodiment of the present invention is preferably performed on a secondary battery with a counter electrode of lithium metal. When a material other than lithium metal is used for the counter electrode, the potential of the positive electrode is difficult to measure because a potential of the secondary battery and the potential of the positive electrode are different from each other. Unless otherwise specified, voltages and potentials in this specification and the like refer to a potential of a positive electrode.

In the case where an all-solid-state secondary battery using, for its negative electrode, a material other than lithium metal such as graphite, silicon, or a lithium titanium oxide is analyzed, it is preferable to disassemble the cell, remove the negative electrode, and then reassemble the cell using a lithium counter electrode. As a method for removing the negative electrode, cutting, shaving, polishing, and the like can be given.

A secondary battery with a counter electrode of lithium metal is subjected to constant current charging under charging conditions of 4.6 V and 0.5 C, and then subjected to constant voltage charging until the current value becomes 0.01 C. Note that here, 1 C is set to 137 mA/g. The temperature is set to 25° C. After the charging is performed in this manner, the coin cell is disassembled in a glove box with an argon atmosphere and the positive electrode is taken out, whereby the high-voltage charged positive electrode can be obtained. The positive electrode is preferably handled in an argon atmosphere also when various analyses are performed. For example, XRD can be performed on the positive electrode enclosed in an airtight container with an argon atmosphere.

### «XRD»

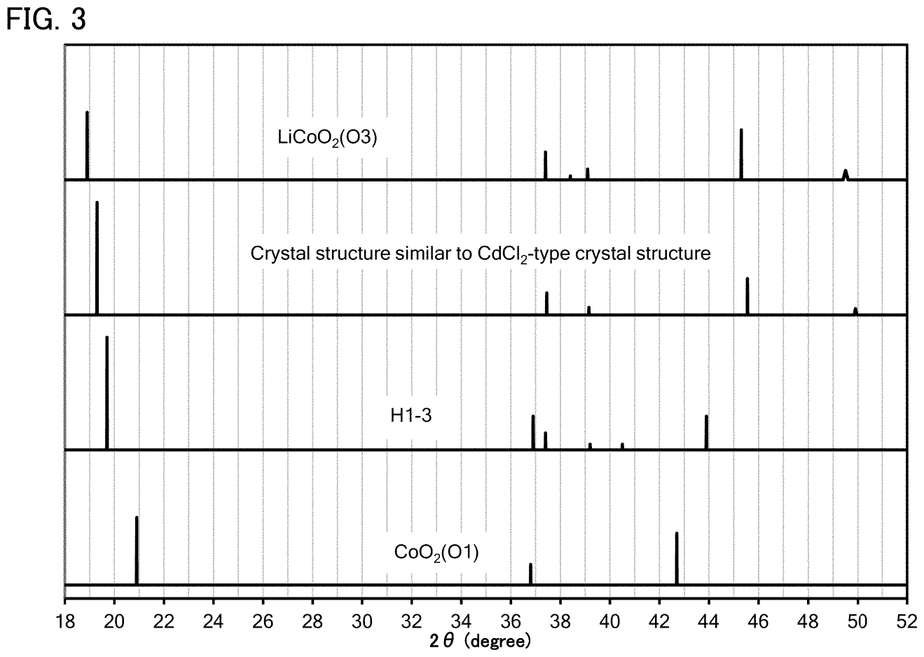

FIG. 3 shows ideal powder XRD patterns with CuKα1 ray that are calculated from models of the crystal structure similar to the CdCl₂-type crystal structure and the H1-3 type crystal structure. In addition, for comparison, ideal XRD patterns calculated from the crystal structures of LiCoO₂(O3) with a depth of charge of 0 and CoO₂(O1) with a depth of charge of 1 are shown. Note that the patterns of LiCoO₂(O3) and CoO₂(O1) are made from crystal structure data obtained from ICSD (Inorganic Crystal Structure Database) using Reflex Powder Diffraction, which is a module of Materials Studio (BIOVIA). The range of 2θ is from 15° to 75°, Step size is 0.01, the wavelength λ1 is 1.540562 Å, λ2 is not set, and Monochromator is a single monochromator. The pattern of the H1-3 type crystal structure is made from the crystal structure data disclosed in Non-Patent Document 3 in a similar manner. The XRD pattern of the crystal structure similar to the CdCl₂-type crystal structure is made in the following manner similar to the others: the crystal structure is estimated from an XRD pattern of the positive electrode active material of one embodiment of the present invention and fitting is performed with TOPAS ver. 3 (crystal structure analysis software manufactured by Bruker Corporation).

As shown in FIG. 3, the crystal structure similar to the CdCl₂-type crystal structure has diffraction peaks at 2θ of 19.30±0.20° (greater than or equal to 19.10° and less than or equal to 19.50°) and 2θ of 45.55±0.10° (greater than or equal to 45.45° and less than or equal to 45.65°). More specifically, sharp diffraction peaks appear at 2θ of 19.30±0.10° (greater than or equal to 19.20° and less than or equal to 19.40°) and 2θ of 45.55±0.05° (greater than or equal to 45.50° and less than or equal to 45.60°). However, the H1-3 type crystal structure and CoO₂ (P-3m1, O1) do not have peaks at these positions. Thus, the peaks at 2θ of 19.30±0.20° and 2θ of 45.55±0.10° in the high-voltage charged state can be the features of the positive electrode active material 111 of one embodiment of the present invention.

It can also be said that the positions of the XRD diffraction peaks in the crystal structure with a depth of charge of 0 are close to those of the XRD diffraction peaks in the high-voltage charged state. More specifically, a difference in the positions of two or more, preferably three or more of the main diffraction peaks between them is 2θ of less than or equal to 0.7, preferably 2θ of less than or equal to 0.5.

Note that although the positive electrode active material 111 of one embodiment of the present invention has the crystal structure similar to the CdCl₂-type crystal structure when charged with high voltage, not all the particles necessarily have the crystal structure similar to the CdCl₂-type crystal structure. The particles may have another crystal structure, or some of the particles may be amorphous. Note that when the XRD patterns are subjected to the Rietveld analysis, the crystal structure similar to the CdCl₂-type crystal structure preferably accounts for more than or equal to 50 wt %, further preferably more than or equal to 60 wt %, still further preferably more than or equal to 66 wt %. The positive electrode active material in which the crystal structure similar to the CdCl₂-type crystal structure accounts for more than or equal to 50 wt %, preferably more than or equal to 60 wt %, further preferably more than or equal to 66 wt % can have sufficiently good cycle performance.

In addition, the crystallite size of a crystal similar to CdCl₂ included in the positive electrode active material particle does not decrease to less than approximately one-tenth that of LiCoO₂(O3) in the discharged state. Thus, a clear peak of the crystal structure similar to the CdCl₂-type crystal structure can be observed after the high-voltage charging even under the same XRD measurement conditions as those of the positive electrode before the charging and discharging. By contrast, simple LiCoO₂ has a small crystallite size and a broad small peak even when it can have a structure part of which is similar to the crystal structure similar to the CdCl₂-type crystal structure. The crystallite size can be calculated from the half width of the XRD peak.

In addition, the layered rock-salt crystal structure included in the particle of the positive electrode active material in the discharged state, which can be estimated from the XRD patterns, preferably has a small lattice constant of the c-axis. The lattice constant of the c-axis increases when a foreign element is substituted at a lithium site or cobalt enters an oxygen-tetracoordinated site (A site), for example. For this reason, the positive electrode active material with excellent cycle performance probably can be formed in the following manner: a composite oxide having a layered rock-salt crystal structure with few foreign element substitutions and Co₃O₄ having the spinel crystal structure, i.e., few defects, is formed; and a magnesium source and a halogen source are mixed with the composite oxide so that magnesium is inserted into the lithium site.

The lattice constant of the c-axis in the crystal structure of the positive electrode active material in the discharged state is preferably less than or equal to 14.060 Å before annealing in a formation process to be described later, further preferably less than or equal to 14.055 Å, still further preferably less than or equal to 14.051 Å. The lattice constant of the c-axis after annealing is preferably less than or equal to 14.060 Å.

In order to set the lattice constant of the c-axis within the above range, the amount of impurities is preferably as small as possible. In particular, the amount of addition of transition metals other than cobalt, manganese, and nickel is preferably as small as possible; specifically, preferably less than or equal to 3,000 ppm, further preferably less than or equal to 1,500 ppm. In addition, cation mixing between lithium and cobalt, manganese, and nickel is preferably less likely to occur.

Note that features that are apparent from the XRD pattern are features of the inner structure of the positive electrode active material. In a positive electrode active material with a particle diameter (D50) of approximately 1 μm to 100 μm, the volume of a surface portion is negligible compared with that of an inner portion; therefore, even when the surface portion of the positive electrode active material 111 has a crystal structure different from that of the inner portion, the crystal structure of the surface portion is highly unlikely to appear in the XRD pattern.

### «ESR»

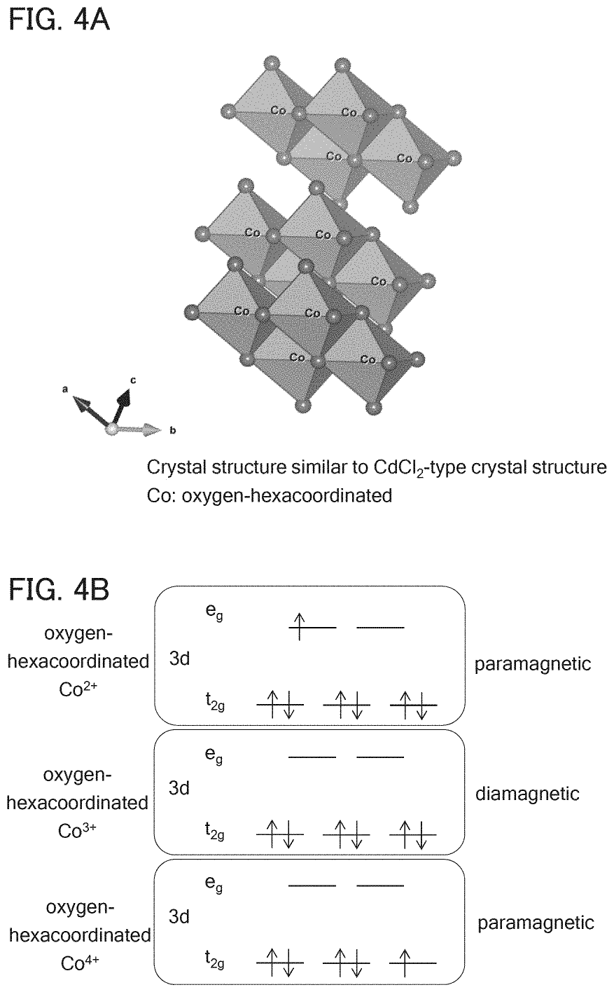

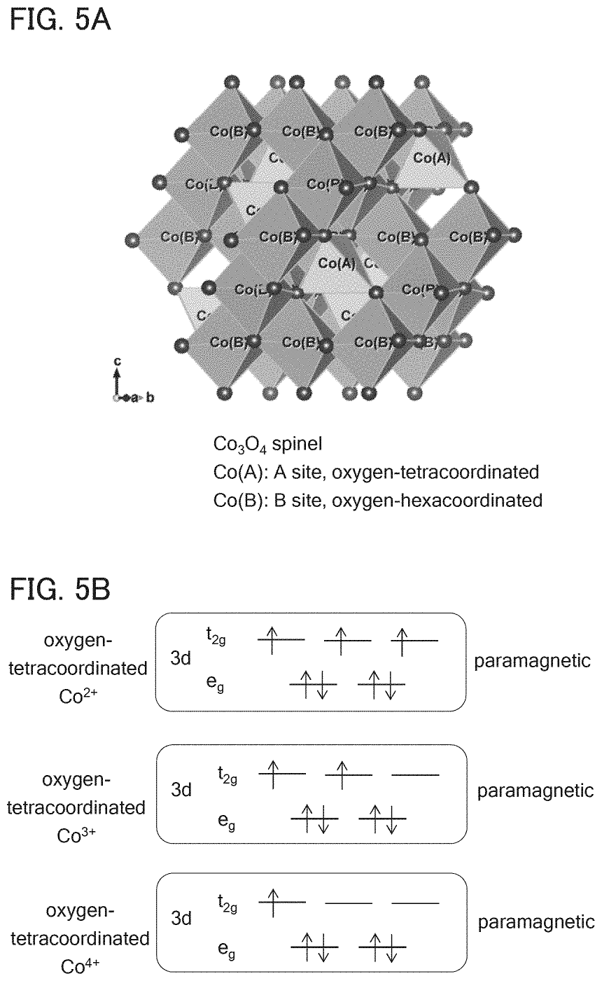

Here, the case in which a difference between the crystal structure similar to the CdCl₂-type crystal structure and another crystal structure is determined using ESR is described with reference to FIG. 4 and FIG. 5. In the crystal structure similar to the CdCl₂-type crystal structure, cobalt exists in the oxygen-hexacoordinated site as illustrated in FIG. 1 and FIG. 4(A). In oxygen-hexacoordinated cobalt, a 3d orbital is divided into an e_{g} orbital and a t_{2g} orbital as shown in FIG. 4(B), and the energy of the t_{2g} orbital located aside from the direction in which oxygen exists is low. Part of cobalt in the oxygen-hexacoordinated site is diamagnetic Co³⁺ in which the entire t_{2g} orbital is filled. Another part of cobalt in the oxygen-hexacoordinated site may be paramagnetic Co²⁺ or Co⁴⁺. Although both Co²⁺ and Co⁴⁺ have one unpaired electron and thus cannot be distinguished from each other by ESR, paramagnetic cobalt may have either valence depending on the valences of surrounding elements.

By contrast, some documents report that a conventional positive electrode active material can have a spinel crystal structure that does not contain lithium in the surface portion in the charged state. In that case, the positive electrode active material contains Co₃O₄ having a spinel crystal structure illustrated in FIG. 5(A).

When the spinel is represented by a general formula A[B₂[O₄, the element A is oxygen-tetracoordinated and the element B is oxygen-hexacoordinated. In this specification and the like, the oxygen-tetracoordinated site is referred to as an A site, and the oxygen-hexacoordinated site is referred to as a B site in some cases.

In Co₃O₄ having the spinel crystal structure, cobalt exists not only in the oxygen-hexacoordinated B site, but also in the oxygen-tetracoordinated A site. In oxygen-tetracoordinated cobalt, between the divided e_{g} orbital and t_{2g} orbital, the e_{g} orbital has lower energy as shown in FIG. 5(B). Thus, each of oxygen-tetracoordinated Co²⁺, Co³⁺, and Co⁴⁺ includes an unpaired electron and therefore is paramagnetic. Accordingly, when the particles that sufficiently contain Co₃O₄ having the spinel crystal structure are analyzed by ESR or the like, the peaks attributed to paramagnetic cobalt, oxygen-tetracoordinated Co²⁺, Co³⁺, or Co⁴⁺, should be detected.

However, in the positive electrode active material 111 of one embodiment of the present invention, the peaks attributed to oxygen-tetracoordinated paramagnetic cobalt are too small to observe. This means, unlike the spinel crystal structure, the crystal structure similar to the CdCl₂-type crystal structure in this specification and the like does not contain an enough amount of oxygen-tetracoordinated cobalt to be detected by ESR. Therefore, the peaks that are attributed to Co₃O₄ having the spinel crystal structure and can be detected by ESR or the like in the positive electrode active material of one embodiment of the present invention are smaller than those in the conventional example, or too small to observe, in some cases. Co₃O₄ having the spinel crystal structure does not contribute to the charge and discharge reaction; thus, the amount of Co₃O₄ having the spinel crystal structure is preferably as small as possible. It can be determined also from the ESR analysis that the positive electrode active material 111 is different from the conventional example.

### «XP»

A region from the surface to approximately 2 nm to 8 nm (normally, approximately 5 nm) can be analyzed by X-ray photoelectron spectroscopy (XPS); thus, the concentration of each element in approximately half of the surface portion can be quantitatively analyzed. The bonding states of the elements can be analyzed by narrow scanning analysis. Note that the quantitative accuracy of XPS is approximately ±1 atomic % in many cases. The lower detection limit is approximately 1 atomic % but depends on the element.

When the positive electrode active material 111 is analyzed by XPS and the cobalt concentration is set to 1, the relative value of the magnesium concentration is preferably greater than or equal to 0.4 and less than or equal to 1.5, further preferably greater than or equal to 0.45 and less than 1.00. Furthermore, the relative value of the concentration of halogen such as fluorine is preferably greater than or equal to 0.05 and less than or equal to 1.5, further preferably greater than or equal to 0.3 and less than or equal to 1.00.

In addition, when the positive electrode active material 111 is analyzed by XPS, a peak indicating the bonding energy of fluorine with another element is preferably higher than or equal to 682 eV and lower than 685 eV, further preferably approximately 684.3 eV. This value is different from both of the bonding energy of LiF, which is 685 eV, and the bonding energy of MgF₂, which is 686 eV. That is, when the positive electrode active material 111 contains fluorine, bonding other than bonding of LiF and MgF₂ is preferable.

Furthermore, when the positive electrode active material 111 is analyzed by XPS, a peak indicating the bonding energy of magnesium with another element is preferably higher than or equal to 1302 eV and lower than 1304 eV, further preferably approximately 1303 eV. This value is different from the bonding energy of MgF₂, which is 1305 eV, and is close to the bonding energy of MgO. That is, when the positive electrode active material 111 contains magnesium, bonding other than bonding of MgF₂ is preferable. «EDX»

In the EDX measurement, to measure a region while scanning is performed and evaluate the region two-dimensionally is referred to as EDX surface analysis in some cases. In addition, to extract data of a linear region from EDX surface analysis and evaluate the atomic concentration distribution in a positive electrode active material particle is referred to as linear analysis in some cases.

The concentrations of magnesium and fluorine in the inner portion, the surface portion, and the vicinity of the crystal grain boundary can be quantitatively analyzed by the EDX surface analysis (e.g., element mapping). In addition, peaks of the concentrations of magnesium and fluorine can be analyzed by the EDX linear analysis.

When the positive electrode active material 111 is subjected to the EDX linear analysis, a peak of the magnesium concentration in the surface portion preferably exists in a region from the surface of the positive electrode active material 111 to a depth of 3 nm toward the center, further preferably to a depth of 1 nm, and still further preferably to a depth of 0.5 nm.

The distribution of fluorine in the positive electrode active material 111 preferably overlaps with the distribution of magnesium. Thus, when the EDX linear analysis is performed, a peak of the fluorine concentration in the surface portion preferably exists in a region from the surface of the positive electrode active material 111 to a depth of 3 nm toward the center, further preferably to a depth of 1 nm, and still further preferably to a depth of 0.5 nm.

When the positive electrode active material 111 is subjected to linear analysis or surface analysis, the atomic ratio of magnesium to cobalt (Mg/Co) in the vicinity of the crystal grain boundary is preferably greater than or equal to 0.020 and less than or equal to 0.50, further preferably greater than or equal to 0.025 and less than or equal to 0.30, and still further preferably greater than or equal to 0.030 and less than or equal to 0.20.

«dQ/dVvsV Curve»

When the positive electrode active material of one embodiment of the present invention is discharged at a low rate such as 0.2 C or less after high-voltage charging, a characteristic change in voltage appears just before the end of discharging, in some cases. This change can be clearly observed by the fact that at least one peak appears within the range to 3.5 V at a constant voltage of a peak which appears around 3.9 V in dQ/dVvsV calculated from a discharge curve.

### [Formation Method of Positive Electrode Active Material]

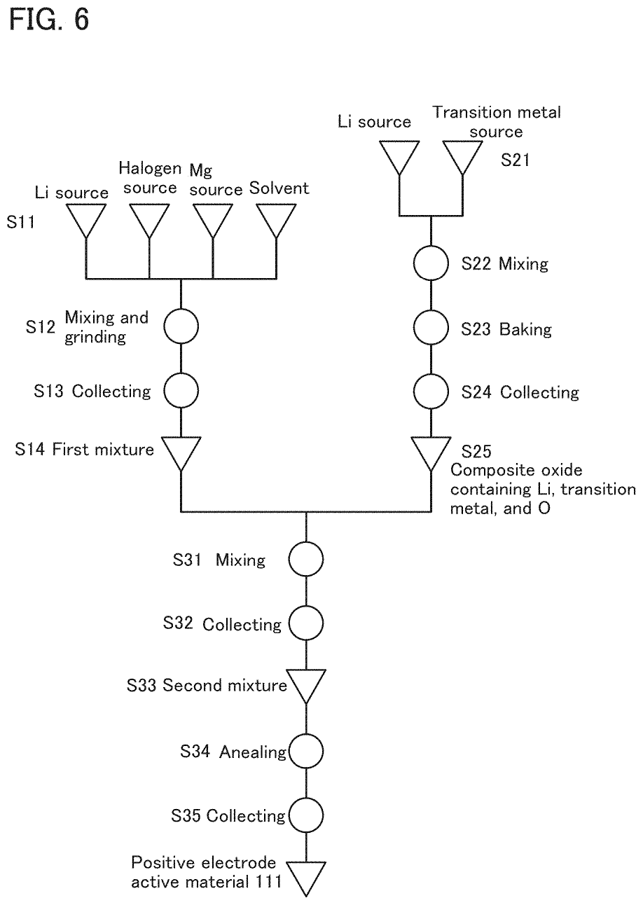

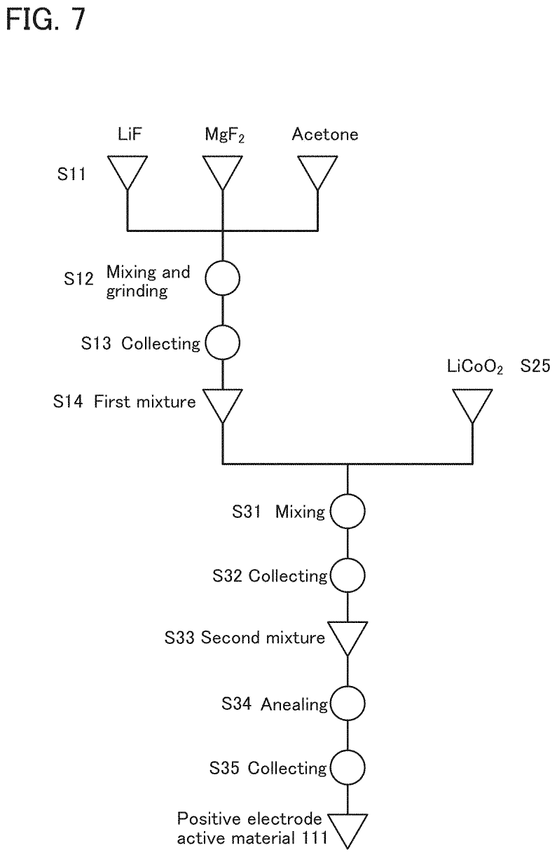

Next, an example of a formation method of the positive electrode active material 111 that can be used for the secondary battery 100 of one embodiment of the present invention will be described with reference to FIG. 6. In addition, FIG. 7 shows a more specific example of the formation method.

### <S11>

As shown in S11 in FIG. 6, a halogen source such as fluorine and a magnesium source are prepared as materials of a first mixture. In addition, a lithium source is prepared.

As the halogen source, for example, lithium fluoride, magnesium fluoride, or the like can be used. Among them, lithium fluoride, which has a relatively low melting point of 848° C., is preferable because it is easily melted in an annealing step described later. As the halogen source, for example, lithium chloride, magnesium chloride, or the like can be used. As the magnesium source, for example, magnesium fluoride, magnesium oxide, magnesium hydroxide, magnesium carbonate, or the like can be used. As the lithium source, for example, lithium fluoride or lithium carbonate can be used. That is, lithium fluoride can be used as both the lithium source and the halogen source. In addition, magnesium fluoride can be used as both the halogen source and the magnesium source.

In this embodiment, lithium fluoride is prepared as the halogen source and the lithium source, and magnesium fluoride is prepared as the halogen source and the magnesium source (S11 in FIG. 7). When lithium fluoride LiF and magnesium fluoride MgF₂ are mixed at LiF:MgF₂=approximately 65:35 (molar ratio), the effect of lowering the melting point is maximized. On the other hand, when the amount of lithium fluoride increases, cycle performance might deteriorate because of an excessive amount of lithium. Therefore, the molar ratio of lithium fluoride LiF to magnesium fluoride MgF₂ is preferably LiF:MgF₂=x:1 (0≤x≤1.9), further preferably LiF:MgF₂=x:1 (0.1≤x≤0.5), still further preferably LiF:MgF₂=x:1 (x=the vicinity of 0.33). Note that in this specification and the like, the vicinity means a value in a range of greater than 0.9 times and smaller than 1.1 times a certain value.

In addition, in the case where the following mixing and grinding step is performed by a wet process, a solvent is prepared. As the solvent, ketone such as acetone; alcohol such as ethanol or isopropanol; ether; dioxane; acetonitrile; N-methyl-2-pyrrolidone (NMP); or the like can be used. An aprotic solvent that hardly reacts with lithium is further preferably used. In this embodiment, acetone is used (see S11 in FIG. 7).

### <S12>

Next, the materials of the first mixture are mixed and ground (S12 in FIG. 6 and FIG. 7). Although the mixing can be performed by a dry process or a wet process, the wet process is preferable because the materials can be ground to the smaller size. For example, a ball mill, a bead mill, or the like can be used for the mixing. When a ball mill is used, zirconia balls are preferably used as media, for example. The mixing and grinding step is preferably performed sufficiently to pulverize the first mixture.

### <S13, S14>

The materials mixed and ground in the above manner are collected (S13 in FIG. 6 and FIG. 7), whereby the first mixture is obtained (S14 in FIG. 6 and FIG. 7).

The first mixture preferably has an average particle diameter (D50) of greater than or equal to 600 nm and less than or equal to 20 μm, further preferably greater than or equal to 1 μm and less than or equal to 10 μm, for example. When mixed with a composite oxide containing lithium, a transition metal, and oxygen in a later step, the first mixture pulverized to such a small size is easily attached to surfaces of composite oxide particles uniformly. The first mixture is preferably attached to the composite oxide particles uniformly because both halogen and magnesium are easily distributed to the surface portion of the composite oxide particles after heating. When there is a region containing neither halogen nor magnesium in the surface portion, the crystal structure similar to the CdCl₂-type crystal structure might be less likely to be obtained in the charged state.

### <S21>

Next, as shown in S21 in FIG. 6, a lithium source and a transition metal source are prepared as materials of the composite oxide containing lithium, the transition metal, and oxygen.

As the lithium source, for example, lithium carbonate, lithium fluoride, or the like can be used.

As the transition metal, at least one of cobalt, manganese, and nickel can be used. An oxide containing lithium, a transition metal, and oxygen preferably has a layered rock-salt crystal structure, and thus cobalt, manganese, and nickel preferably have a mixing ratio at which the oxide can have the layered rock-salt crystal structure. In addition, aluminum may be added to the transition metal as long as the oxide can have the layered rock-salt crystal structure.

As the transition metal source, oxide or hydroxide of the transition metal, or the like can be used. As the cobalt source, for example, cobalt oxide, cobalt hydroxide, or the like can be used. As the manganese source, manganese oxide, manganese hydroxide, or the like can be used. As the nickel source, nickel oxide, nickel hydroxide, or the like can be used. As the aluminum source, aluminum hydroxide, aluminum oxide, or the like can be used.

### <S22>

Next, the lithium source and the transition metal source are mixed (S22). The mixing can be performed by a dry process or a wet process. For example, a ball mill, a bead mill, or the like can be used for the mixing. When a ball mill is used, zirconia balls are preferably used as media, for example.

### <S23>

Next, the materials mixed in the above manner are heated. This step is sometimes referred to as baking or first heating to distinguish this step from a heating step performed later. The heating is preferably performed at higher than or equal to 800° C. and lower than 1100° C., further preferably at higher than or equal to 900° C. and lower than or equal to 1000° C., still further preferably at approximately 950° C. Excessively low temperature might result in insufficient decomposition and melting of the starting materials. By contrast, excessively high temperature might cause a defect due to excessive reduction of the transition metal, evaporation of lithium, or the like. For example, a defect in which cobalt has a valence of two might be caused.

The heating time is preferably longer than or equal to 2 hours and shorter than or equal to 20 hours. Baking is preferably performed in an atmosphere with few moisture, such as dry air (e.g., a dew point is lower than or equal to −50° C., further preferably lower than or equal to 100° C.). For example, it is preferable that the heating be performed at 1000° C. for 10 hours, the temperature rise be 200° C./h, and the flow rate of a dry atmosphere be 10 L/min. After that, the heated materials are cooled to room temperature. The temperature decreasing time from the specified temperature to room temperature is preferably longer than or equal to 10 hours and shorter than or equal to 50 hours, for example.

### <S24, S25>

The materials baked in the above manner are collected (S24), whereby the composite oxide containing lithium, the transition metal, and oxygen is obtained (S25). Specifically, lithium cobalt oxide, lithium manganese oxide, lithium nickel oxide, lithium cobalt oxide in which manganese is substituted for part of cobalt, or lithium nickel-manganese-cobalt oxide is obtained.

Alternatively, a composite oxide containing lithium, a transition metal, and oxygen that is synthesized in advance may be used in S25 (see FIG. 7). In that case, S21 to S24 can be omitted.

In the case where a composite oxide containing lithium, a transition metal, and oxygen that is synthesized in advance is used, a composite oxide with few impurities is preferably used. Here, lithium, the transition metal (cobalt, nickel, or manganese), aluminum, and oxygen are the main components, and elements other than the main components are regarded as impurities. For example, in analysis by glow discharge mass spectrometry, the total impurity element concentration is preferably less than or equal to 10,000 ppm wt, further preferably less than or equal to 5,000 ppm wt. In particular, the total impurity concentration of transition metals such as titanium and arsenic is preferably less than or equal to 3,000 ppm, further preferably less than or equal to 1,500 ppm.

The composite oxide containing lithium, the transition metal, and oxygen in S25 preferably has a layered rock-salt crystal structure with few defects and distortions. Therefore, the composite oxide is preferably a composite oxide that includes few impurities. In the case where the composite oxide containing lithium, the transition metal, and oxygen includes a lot of impurities, the crystal structure is highly likely to have a lot of defects or distortions.

### <S31>

Next, the first mixture and the composite oxide containing lithium, the transition metal, and oxygen are mixed (S31). The atomic ratio of the transition metal TM in the composite oxide containing lithium, the transition metal, and oxygen to magnesium Mg_{Mix1} contained in the first mixture Mix1 is preferably TM:Mg_{Mix1}=1:y (0.0005≤y≤0.03), further preferably TM:Mg_{Mix1}=1:y (0.001≤y≤0.01), still further preferably approximately TM:Mg_{Mix1}=1:0.005.

The condition of the mixing in S31 is preferably milder than that of the mixing in S12 not to damage the composite oxide particles. The mixing can be performed by a dry process or a wet process. For example, a ball mill, a bead mill, or the like can be used for the mixing. When a ball mill is used, zirconia balls are preferably used as media, for example.

### <S32, S33>

The materials mixed in the above manner are collected (S32), whereby a second mixture is obtained (S33).

Note that this embodiment describes a method for adding the mixture of lithium fluoride and magnesium fluoride to lithium cobalt oxide with few impurities; however, one embodiment of the present invention is not limited thereto. Mixture obtained through baking after addition of a magnesium source and a halogen source to the starting materials of lithium cobalt oxide may be used instead of the second mixture in S33. In that case, there is no need to separate steps S11 to S14 and steps S21 to S25, which is simple and productive.

Alternatively, lithium cobalt oxide to which magnesium and fluorine are added in advance may be used. When lithium cobalt oxide to which magnesium and fluorine are added is used, the process can be simpler because the steps up to S32 can be omitted.

In addition, a magnesium source and a halogen source may be further added to lithium cobalt oxide to which magnesium and fluorine are added in advance.

### <S34>

Next, the second mixture is heated. This step is sometimes referred to as annealing or second heating to distinguish this step from the heating step performed before.

The annealing is preferably performed at an appropriate temperature for an appropriate time. The appropriate temperature and time depend on the conditions such as the particle size and composition of the composite oxide containing lithium, the transition metal, and oxygen in S25. In the case where the particle size is small, the annealing is preferably performed at a lower temperature or for a shorter time than annealing in the case where the particle size is large, in some cases.

When the average particle diameter (D50) of the particles in S25 is approximately 12 μm, for example, the annealing temperature is preferably higher than or equal to 600° C. and lower than or equal to 950° C., for example. The annealing time is preferably longer than or equal to three hours, further preferably longer than or equal to 10 hours, still further preferably longer than or equal to 60 hours, for example.

On the other hand, when the average particle diameter (D50) of the particles in S25 is approximately 5 μm, the annealing temperature is preferably higher than or equal to 600° C. and lower than or equal to 950° C., for example. The annealing time is preferably longer than or equal to 1 hour and shorter than or equal to 10 hours, further preferably approximately 2 hours, for example.

The temperature decreasing time after the annealing is, for example, preferably longer than or equal to 10 hours and shorter than or equal to 50 hours.

It is considered that when the second mixture is annealed, the material having a low melting point (e.g., lithium fluoride, which has a melting point of 848° C.) in the first mixture is melted first and distributed to the surface portion of the composite oxide particle. Next, the existence of the melted material decreases the melting points of the other materials, presumably resulting in melting of the other materials. For example, magnesium fluoride (melting point: 1263° C.) is presumably melted and distributed to the surface portion of the composite oxide particle.

Then, the elements that are included in the first mixture and are distributed to the surface portion probably enter the composite oxide containing lithium, the transition metal, and oxygen to form a solid solution.

The elements included in the first mixture diffuse faster in the surface portion and the grain boundary than inside the composite oxide particles. Therefore, the concentrations of magnesium and halogen in the surface portion and the grain boundary are higher than those of magnesium and halogen inside the composite oxide particles. As described later, the higher the magnesium concentration in the surface portion and the grain boundary is, the more effectively the change in the crystal structure can be suppressed.

### <S35>

The materials annealed in the above manner are collected, whereby the positive electrode active material 111 of one embodiment of the present invention is obtained.

When manufactured by a method like that in FIG. 6 and FIG. 7, the positive electrode active material having the crystal structure similar to the CdCl₂-type crystal structure with few defects in high-voltage charging can be formed. A positive electrode active material in which the crystal structure similar to the CdCl₂-type crystal structure accounts for more than or equal to 50% when analyzed by Rietveld analysis has excellent cycle performance and rate characteristics.

To include magnesium and fluorine in the positive electrode active material and to anneal the positive electrode active material at an appropriate temperature for an appropriate time are effective in forming the positive electrode active material having the crystal structure similar to the CdCl₂-type crystal structure after high-voltage charging. Magnesium and fluorine may be added to the starting materials of the composite oxide. However, when the melting points of the magnesium source and the halogen source are higher than the baking temperature, the magnesium source and the halogen source added to the starting materials of the composite oxide might not be melted, resulting in insufficient diffusion. Then, there is a high possibility that the layered rock-salt crystal structure has a lot of defects or distortions. As a result, the crystal structure similar to the CdCl₂-type crystal structure after high-voltage charging also might have defects or distortions.

Thus, it is preferable that a composite oxide having a layered rock-salt crystal structure with few impurities and few defects or distortions be obtained first. Then, the composite oxide, the magnesium source, and the halogen source are preferably mixed and annealed in the later steps to form a solid solution of magnesium and fluorine in the surface portion of the composite oxide. In this matter, the positive electrode active material having the crystal structure similar to the CdCl₂-type crystal structure with few defects or distortions after high-voltage charging can be formed.

### Embodiment 2

In this embodiment, a structure of the secondary battery 100 and materials other than the positive electrode active material 111 described in Embodiment 1, which can be used for the secondary battery 100 of one embodiment of the present invention, will be described.

### <Structure of Secondary Battery>

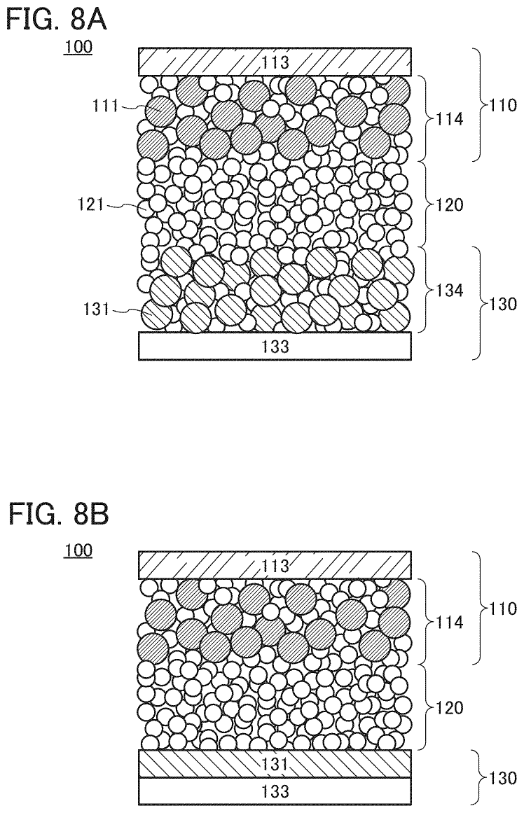

As illustrated in FIG. 8(A), the secondary battery 100 of one embodiment of the present invention includes a positive electrode 110, a solid electrolyte layer 120, and a negative electrode 130.

The positive electrode 110 includes a positive electrode current collector 113 and a positive electrode active material layer 114. The positive electrode active material layer 114 includes the positive electrode active material 111 and a solid electrolyte 121. The positive electrode active material layer 114 may also include a conductive additive and a binder.

The solid electrolyte layer 120 includes the solid electrolyte 121. The solid electrolyte layer 120 is positioned between the positive electrode 110 and the negative electrode 130, and is a region that includes neither the positive electrode active material 111 nor a negative electrode active material 131.

The negative electrode 130 includes a negative electrode current collector 133 and a negative electrode active material layer 134. The negative electrode active material layer 134 includes the negative electrode active material 131 and the solid electrolyte 121. The negative electrode active material layer 134 may also include a conductive additive and a binder. Note that when metal lithium is used for the negative electrode 130, it is possible that the negative electrode 130 does not include the solid electrolyte 121 as illustrated in FIG. 8(B). The use of metal lithium for the negative electrode 130 is preferable because the energy density of the secondary battery 100 can be increased.

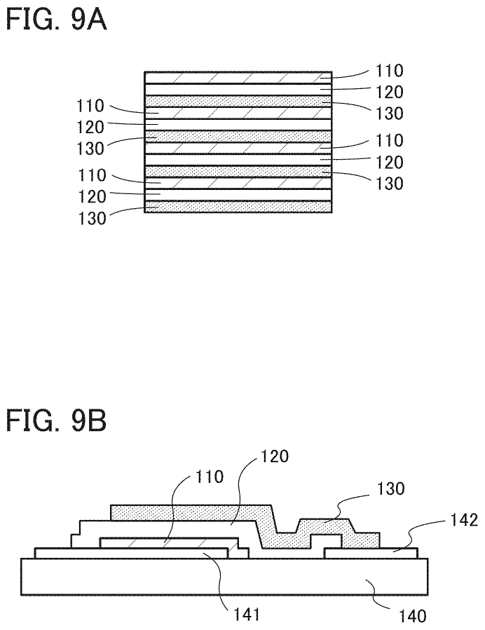

As illustrated in FIG. 9(A), the secondary battery may have a structure in which a combination of the positive electrode 110, the solid electrolyte layer 120, and the negative electrode 130 is repeatedly stacked. Stacking the positive electrodes 110, the solid electrolyte layers 120, and the negative electrodes 130 can increase the voltage of the secondary battery. FIG. 9(A) is a schematic diagram illustrating the case where four layers of the combination of the positive electrode 110, the solid electrolyte layer 120, and the negative electrode 130 are stacked.

The secondary battery 100 of one embodiment of the present invention may be a thin-film all-solid-state battery. A thin-film all-solid-state battery can be manufactured by depositing a positive electrode, a solid electrolyte, a negative electrode, a wiring electrode, and the like by a vapor phase method (a vacuum deposition method, a pulsed laser deposition method, an aerosol deposition method, or a sputtering method). For example, as illustrated in FIG. 9(B), after a wiring electrode 141 and a wiring electrode 142 are formed over a substrate 140, the positive electrode 110 is formed over the wiring electrode 141, the solid electrolyte layer 120 is formed over the positive electrode 110, and the negative electrode 130 is formed over the solid electrolyte layer 120 and the wiring electrode 142, whereby the secondary battery 100 can be manufactured. As the substrate 140, a ceramic substrate, a glass substrate, a plastic substrate, a metal substrate, or the like can be used.

### <Positive Electrode>

As the positive electrode active material 111 included in the positive electrode 110, the positive electrode active material 111 described in Embodiment 1 is preferably used. The positive electrode active material 111 described in Embodiment 1 is preferable because a volume change caused by charging and discharging is reduced and thus a conduction path of lithium ions is easily kept even in an all-solid-state secondary battery.

A material that has high conductivity, such as a metal like stainless steel, silver, gold, platinum, aluminum, titanium, or the like; or an alloy thereof can be used for the positive electrode current collector 113. In addition, it is preferable that a material used for the positive electrode current collector not dissolve at the potential of the positive electrode. Alternatively, an aluminum alloy to which an element that improves heat resistance, such as silicon, titanium, neodymium, scandium, or molybdenum, is added can be used. Alternatively, the positive electrode current collector may be formed using a metal element that forms silicide by reacting with silicon. Examples of the metal element that forms silicide by reacting with silicon include zirconium, titanium, hafnium, vanadium, niobium, tantalum, chromium, molybdenum, tungsten, cobalt, nickel, and the like. For the current collector, a shape such as a foil-like shape, a plate-like shape (sheet-like shape), a net-like shape, a punching-metal shape, or an expanded-metal shape can be used as appropriate.

Alternatively, a conductive layer formed by applying a metal nano-ink or a metal paste typified by a silver paste, a gold paste, or a platinum paste may be used as the positive electrode current collector 113. Alternatively, a conductive layer formed by sputtering, CVD, evaporation, or the like may be used, for example.

As the conductive additive, a carbon material, a metal material, a conductive ceramic material, or the like can be used. Alternatively, a fibrous material may be used as the conductive additive. A network for electric conduction can be formed in the active material layer by the conductive additive. The conductive additive can maintain an electric conduction path between positive electrode active materials. The addition of the conductive additive to the active material layer can achieve an active material layer with high electric conductivity.

For example, natural graphite, artificial graphite such as mesocarbon microbeads, carbon fiber, or the like can be used as the conductive additive. For example, carbon fiber such as mesophase pitch-based carbon fiber or isotropic pitch-based carbon fiber can be used as the carbon fiber. Alternatively, carbon nanofiber, carbon nanotube, or the like can be used as the carbon fiber. Carbon nanotube can be manufactured by, for example, a vapor deposition method or the like. Alternatively, for example, a carbon material such as carbon black (acetylene black (AB) or the like), graphite (black lead) particles, graphene, or fullerene can be used as the conductive additive. Alternatively, for example, metal powder or metal fiber of copper, nickel, aluminum, silver, gold, or the like, a conductive ceramic material, or the like can be used.

Alternatively, a graphene compound may be used as the conductive additive.

A graphene compound has excellent electrical characteristics of high conductivity and excellent physical properties of high flexibility and high mechanical strength in some cases. Furthermore, a graphene compound has a planar shape. A graphene compound enables low-resistance surface contact. Furthermore, a graphene compound has extremely high conductivity even with a small thickness in some cases and thus allows a conductive path to be formed in an active material layer efficiently even with a small amount. Thus, a graphene compound is preferably used as the conductive additive, in which case the area where the active material and the conductive additive are in contact can be increased. A graphene compound that is the conductive additive is preferably formed using a spray dry apparatus as a coating film to cover the entire surface of the active material. In addition, a graphene compound is preferable because electrical resistance can be reduced in some cases. Here, it is particularly preferable to use, for example, graphene, multilayer graphene, or RGO as a graphene compound. Here, RGO refers to a compound obtained by reducing graphene oxide (GO), for example.

In the case where an active material with a small particle diameter of 1 μm or less, for example, is used, the specific surface area of the active material is large and thus more conductive paths for connecting active materials with each other are needed. Thus, the amount of the conductive additive tends to increase and the carried amount of the active material tends to decrease relatively. When the carried amount of the active material decreases, the capacity of the secondary battery decreases. In such a case, the use of a graphene compound as the conductive additive is particularly preferable because the graphene compound can efficiently form conductive paths even with a small amount and thus the carried amount of the active material does not decrease.

A rubber material such as styrene-butadiene rubber (SBR), styrene-isoprene-styrene rubber, acrylonitrile-butadiene rubber, butadiene rubber, or ethylene-propylene-diene copolymer is preferably used as the binder, for example. Alternatively, fluororubber can be used as the binder.

In addition, for example, a water-soluble high molecule is preferably used as the binder. As the water-soluble high molecule, for example, a polysaccharide can be used. As the polysaccharide, a cellulose derivative such as carboxymethyl cellulose (CMC), methyl cellulose, ethyl cellulose, hydroxypropyl cellulose, diacetyl cellulose, or regenerated cellulose, starch, or the like can be used. Furthermore, it is further preferable that such a water-soluble high molecule be used in combination with the above rubber material.

Alternatively, a material such as polystyrene, poly(methyl acrylate), poly(methyl methacrylate) (PMMA), sodium polyacrylate, polyvinyl alcohol (PVA), polyethylene oxide (PEO), polypropylene oxide, polyimide, polyvinyl chloride, polytetrafluoroethylene, polyethylene, polypropylene, polyisobutylene, polyethylene terephthalate, nylon, polyvinylidene fluoride (PVdF), polyacrylonitrile (PAN), ethylene-propylene-diene polymer, polyvinyl acetate, or nitrocellulose is preferably used as the binder.

A plurality of the above materials may be used in combination as the binder.

For example, a material having an especially significant viscosity modifying effect and another material may be used in combination. For example, a rubber material or the like has high adhesion or high elasticity but may have difficulty in viscosity modification when mixed in a solvent. In such a case, the rubber material or the like is preferably mixed with a material having an especially significant viscosity modifying effect, for example. As the material having an especially significant viscosity modifying effect, for example, a water-soluble high molecule is preferably used. In addition, as a water-soluble high molecule having an especially significant viscosity modifying effect, the above-mentioned polysaccharide, for example, a cellulose derivative such as carboxymethyl cellulose (CMC), methyl cellulose, ethyl cellulose, hydroxypropyl cellulose, diacetyl cellulose, or regenerated cellulose, or starch can be used.

Note that a cellulose derivative such as carboxymethyl cellulose has a higher solubility when changed into a salt such as a sodium salt or an ammonium salt of carboxymethyl cellulose, and accordingly, easily exerts an effect as a viscosity modifier. The higher solubility can also increase the dispersibility of an active material and other components in the formation of slurry for an electrode. In this specification, cellulose and a cellulose derivative used as a binder of an electrode include salt thereof.

The water-soluble high molecule stabilizes viscosity by being dissolved in water and allows stable dispersion of the active material and another material combined as a binder, for example, styrene-butadiene rubber, in an aqueous solution. Furthermore, the water-soluble high molecule is expected to be easily and stably adsorbed to an active material surface because it has a functional group. In addition, for example, many cellulose derivatives such as carboxymethyl cellulose have functional groups such as a hydroxyl group and a carboxyl group. Because the cellulose derivatives have the functional groups, high molecules are expected to interact with each other and widely cover an active material surface.

### <Negative Electrode>

For example, lithium metal, an alloy-based material, a carbon-based material, or the like can be used as the negative electrode active material 131 included in the negative electrode 130.

Lithium metal is preferably used as the negative electrode active material 131 because the energy density of the secondary battery can be significantly increased.

As the negative electrode active material, an element that enables charge and discharge reaction by alloying reaction and dealloying reaction with lithium can be used. For example, a material containing at least one of silicon, tin, gallium, aluminum, germanium, lead, antimony, bismuth, silver, zinc, cadmium, indium, and the like can be used. Such elements have higher capacity than carbon. In particular, silicon has a high theoretical capacity of 4200 mAh/g. For this reason, silicon is preferably used as the negative electrode active material. Alternatively, a compound containing the element may be used. Examples of the compound include SiO, Mg₂Si, Mg₂Ge, SnO, SnO₂, Mg₂Sn, SnS₂, V₂Sn₃, FeSn₂, CoSn₂, Ni₃Sn₂, Cu₆Sn₅, Ag₃Sn, Ag₃Sb, Ni₂MnSb, CeSb₃, LaSn₃, La₃Co₂Sn₇, CoSb₃, InSb, and SbSn. Here, the element that enables charge and discharge reaction by alloying reaction and dealloying reaction with lithium, the compound containing the element, and the like may be referred to as an alloy-based material.

In this specification and the like, SiO refers to, for example, silicon monoxide. Alternatively, SiO can be expressed as SiOₓ. Here, x preferably has an approximate value of 1. For example, x is preferably more than or equal to 0.2 and less than or equal to 1.5, further preferably more than or equal to 0.3 and less than or equal to 1.2.

As the carbon-based material, graphite, graphitizing carbon (soft carbon), non-graphitizing carbon (hard carbon), carbon nanotube, graphene, carbon black, or the like may be used.

Examples of graphite include artificial graphite, natural graphite, and the like. Examples of artificial graphite include mesocarbon microbeads (MCMB), coke-based artificial graphite, pitch-based artificial graphite, and the like. Here, as artificial graphite, spherical graphite having a spherical shape can be used. For example, MCMB is preferable because it has a spherical shape in some cases. Moreover, MCMB is preferable in some cases because it can relatively easily have a smaller surface area. Examples of natural graphite include flake graphite, spherical natural graphite, and the like.

Graphite has a low potential substantially equal to that of lithium metal (higher than or equal to 0.05 V and lower than or equal to 0.3 V vs. Li/Li⁺) when lithium ions are inserted into graphite (while a lithium-graphite intercalation compound is formed). For this reason, a lithium-ion secondary battery can exhibit a high operating voltage. In addition, graphite is preferable because of its advantages such as a relatively high capacity per unit volume, relatively small volume expansion, low cost, and higher safety than that of lithium metal.

Alternatively, as the negative electrode active material, an oxide such as titanium dioxide (TiO₂), lithium titanium oxide (Li₄Ti₅O₁₂), a lithium-graphite intercalation compound (LiₓC₆), niobium pentoxide (Nb₂O₅), tungsten oxide (WO₂), or molybdenum oxide (MoO₂) can be used.

Alternatively, as the negative electrode active material, Li₃₋ₓMₓN (M=Co, Ni, or Cu) with a Li₃N structure, which is a nitride of lithium and a transition metal, can be used. For example, Li_{2.6}Co_{0.4}N₃ is preferable because of its high charge and discharge capacity (900 mAh/g and 1890 mAh/cm³).

A nitride of lithium and a transition metal is preferably used, in which case lithium ions are contained in the negative electrode active material and thus the negative electrode active material can be combined with a material for a positive electrode active material which does not contain lithium ions, such as V₂O₅ or Cr₃O₈. Note that even in the case of using a material containing lithium ions for the positive electrode active material, the nitride of lithium and the transition metal can be used as the negative electrode active material by extracting the lithium ions contained in the positive electrode active material in advance.

In addition, a material which causes conversion reaction can also be used as the negative electrode active material. For example, a transition metal oxide which does not form an alloy with lithium, such as cobalt oxide (CoO), nickel oxide (NiO), or iron oxide (FeO), may be used as the negative electrode active material. Other examples of the material which causes conversion reaction include oxides such as Fe₂O₃, CuO, Cu₂O, RuO₂, and Cr₂O₃, sulfides such as CoS_{0.89}, NiS, and CuS, nitrides such as Zn₃N₂, Cu₃N, and Ge₃N₄, phosphides such as NiP₂, FeP₂, and CoP₃, and fluorides such as FeF₃ and BiF₃.

Furthermore, a surface portion of the negative electrode active material may be covered with a solid electrolyte. For example, the surface portion of the negative electrode active material may be covered with an oxide-based solid electrolyte and a sulfide-based solid electrolyte.

As the conductive additive and the binder that can be included in the negative electrode active material layer, materials similar to those of the conductive additive and the binder that can be included in the positive electrode active material layer can be used.

Copper foil, a copper paste, or the like can be used for the negative electrode current collector 133 in addition to materials similar to those of the positive electrode current collector. Note that a material which is not alloyed with carrier ions of lithium or the like is preferably used for the negative electrode current collector.

### <Solid Electrolyte Layer>

As the solid electrolyte 121 included in the solid electrolyte layer 120, a sulfide-based solid electrolyte, an oxide-based solid electrolyte, or a halide-based solid electrolyte can be used, for example.

Examples of the sulfide-based solid electrolyte include a thio-silicon-based material (e.g., Li₁₀GeP₂S₁₂ and Li_{3.25}Ge_{0.25}P_{0.75}S₄), sulfide glass (e.g., 70Li₂S·30P₂S₅, 30Li₂S·26B₂S₃·44LiI, 63Li₂S·38SiS₂·1Li₃PO₄, 57Li₂S·38SiS₂·5Li₄SiO₄, and 50Li₂S·50GeS₂), and sulfide-based crystallized glass (e.g., Li₇P₃S₁₁ and Li_{3.25}P_{0.95}S₄). The sulfide-based solid electrolyte has advantages such as high conductivity of some materials, low-temperature synthesis, and ease of maintaining a conduction path after charging and discharging because of its relative softness.

Examples of the oxide-based solid electrolyte include a material with a perovskite crystal structure (e.g., La_{2/3-x}Li₃ₓTiO₃), a material with a NASICON crystal structure (e.g., Li₁₋ₓAlₓTi₂₋ₓ(PO₄)₃), a material with a garnet crystal structure (e.g., Li₇La₃Zr₂O₁₂), a material with a LISICON crystal structure (e.g., Li₁₄ZnGe₄O₁₆), LLZO (Li₇La₃Zr₂O₁₂), oxide glass (e.g., Li₃PO₄—Li₄SiO₄ and 50Li₄SiO₄·50Li₃BO₃), and oxide-based crystallized glass (e.g., Li_{1.07}Al_{0.69}Ti_{1.46}(PO₄)₃ and Li_{1.5}Al_{0.5}Ge_{1.5}(PO₄)₃). The oxide-based solid electrolyte has an advantage of stability in the air.

Examples of the halide-based solid electrolyte include LiAlCl₄, Li₃InBr₆, LiF, LiCl, LiBr, and LiI. Moreover, a composite material in which pores of porous aluminum oxide or porous silica are filled with such a halide-based solid electrolyte can be used as the solid electrolyte.

Alternatively, different solid electrolytes may be mixed and used.

### «LATP»

In particular, Li₁₊ₓAlₓTi₂₋ₓ(PO₄)₃ (0<x<1) with a NASICON crystal structure (hereinafter LATP) is preferable because LATP contains aluminum and titanium, each of which is the element the positive electrode active material 111 used for the secondary battery 100 of one embodiment of the present invention is allowed to contain, and thus a synergistic effect of improving the cycle performance is expected. Moreover, higher productivity due to the reduction in the number of steps is expected. Note that in this specification and the like, a material with a NASICON crystal structure refers to a compound that is represented by M₂(XO₄)₃ (M: transition metal; X: S, P, As, Mo, W, or the like) and has a structure in which MO₆ octahedra and XO₄ tetrahedra that share common corners are arranged three-dimensionally.

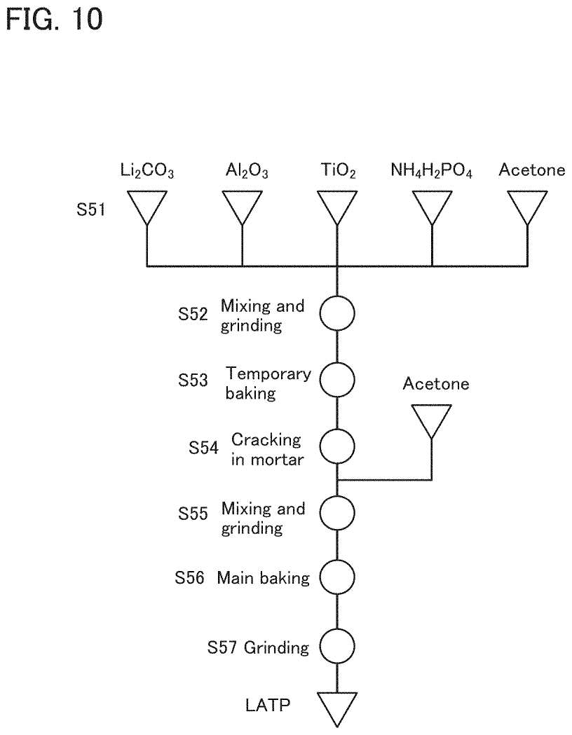

An example of a formation method of LATP will be described with reference to FIG. 10.

### «S51»

First, a lithium source, an aluminum source, a titanium source, and a phosphorus source are prepared as materials of LATP. In S51 in FIG. 10, lithium carbonate is used as the lithium source, aluminum oxide is used as the aluminum source, titanium oxide is used as the titanium source, and ammonium dihydrogen phosphate is used as the phosphorus source.

In addition, in the case where the following mixing and grinding step is performed by a wet process, a solvent is prepared. An aprotic solvent is preferably used. In S51 in FIG. 10, acetone is used as the solvent.

### «S52»

Next, the above materials are mixed and ground (S52 in FIG. 10). Although the mixing can be performed by a dry process or a wet process, the wet process is preferable because the materials can be ground to a smaller size. For example, a ball mill, a bead mill, or the like can be used for the mixing. When a ball mill is used, zirconia balls are preferably used as media, for example. For example, it is possible to perform ball mill process for 2 hours at 300 rpm with a wet process ball mill using zirconia balls.

### «S53»

Then, the materials mixed and ground in the above are heated (S53 in FIG. 10). This step is sometimes referred to as temporary baking or first heating to distinguish this step from a later heating step. The heating is preferably performed at higher than or equal to 170° C. and lower than 500° C., further preferably higher than or equal to 350° C. and lower than 450° C. The heating temperature needs to be higher than the decomposition temperature of the material used as the phosphorus source; however, when the heating temperature is too high, titanium oxide might be changed to have a rutile crystal structure, for example. For example, the heating can be performed at 400° C. in a nitrogen atmosphere for 10 hours. The temperature rising rate can be 200° C./hour.

### «S54»

Next, the materials heated in the above are cracked in a mortar (S54 in FIG. 10).

«S55»Furthermore, mixing and grinding are performed using a ball mill, a bead mill, or the like (S55 in FIG. 10). The mixing can be performed by a dry process or a wet process. In the case where the mixing is performed by a wet process, a solvent is added. The mixing and grinding in this step are preferably performed sufficiently because LATP with few impurities can be synthesized. For example, it is possible to perform ball mill process for 20 hours at 400 rpm with a wet process ball mill using acetone as the solvent.

«S56»

Then, the materials mixed and ground in the above are heated (S56 in FIG. 10). This step is sometimes referred to as main baking or second heating to distinguish this step from the previous heating step. The heating is preferably performed at higher than or equal to 723° C. and lower than or equal to 1000° C., further preferably higher than or equal to 800° C. and lower than 950° C. When the heating temperature is too low, lithium carbonate might not be decomposed and the synthesis of LATP might not proceed sufficiently. In contrast, when the temperature is too high, lithium might evaporate, for example. For example, the heating can be performed at 900° C. in an dry air atmosphere (dew point of −50° C. or lower) for 2 hours. The temperature rising rate can be 200° C./hour.

The main baking in S56 may also serve as the annealing in the formation process of the positive electrode active material 111 (S34 in FIG. 6 and FIG. 7), for example. When the main baking in S56 also serves as the annealing in the formation process of the positive electrode active material 111, the heating step can be reduced and the productivity can be improved.

### «S57»

Next, the materials heated in the above may be ground (S57 in FIG. 10). The grinding is performed for 6 hours at 300 rpm with a ball mill after cracking in a mortar is performed, for example. After that, the materials may be put through a sieve having a sieve opening of 32 μm.

Through the above steps, LATP can be obtained.

### <Exterior Body and Shape of Secondary Battery>

An exterior body of the secondary battery 100 of one embodiment of the present invention can be formed using a variety of materials and have a variety of shapes, and preferably has a function of applying pressure to the positive electrode, the solid electrolyte layer, and the negative electrode.

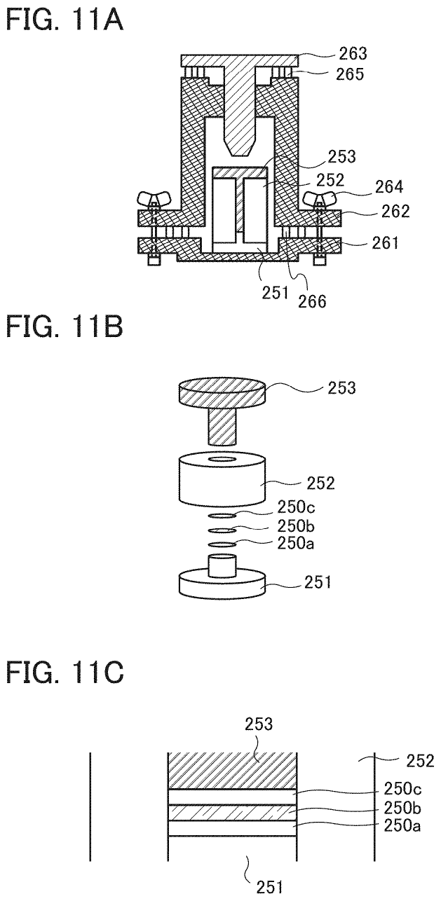

FIG. 11 shows an example of a cell for evaluating materials of an all-solid-state battery.

FIG. 11(A) is a schematic cross-sectional view of an evaluation cell. The evaluation cell includes a lower component 261, an upper component 262, and a fixation screw and a butterfly nut 264 for fixing them. By rotating a pressure screw 263, an electrode plate 253 is pressed to fix an evaluation material. An insulator 266 is provided between the lower component 261 and the upper component 262 that are made of a stainless steel material. An O ring 265 for hermetic sealing is provided between the upper component 262 and the pressure screw 263.

The evaluation material is placed on an electrode plate 251, surrounded by an insulating tube 252, and pressed from above by the electrode plate 253. FIG. 11(B) is an enlarged perspective view of the evaluation material and its vicinity.

A stack of a positive electrode 250a, a solid electrolyte layer 250b, and a negative electrode 250c is shown as an example of the evaluation material, and its cross section is shown in FIG. 11(C). Note that the same portions in FIGS. 11(A), 11(B), and 11(C) are denoted by the same reference numerals.

The electrode plate 251 and the lower component 261 that are electrically connected to the positive electrode 250a can be said to correspond to a positive electrode terminal. The electrode plate 253 and the upper component 262 that are electrically connected to the negative electrode 250c can be said to correspond to a negative electrode terminal. The electric resistance or the like can be measured while pressure is applied to the evaluation material through the electrode plate 251 and the electrode plate 253.

The exterior body of the secondary battery of one embodiment of the present invention is preferably a package having excellent airtightness. For example, a ceramic package or a resin package can be used. Sealing of the exterior body is preferably performed in a closed atmosphere, for example, in a glove box, in which air is blocked.

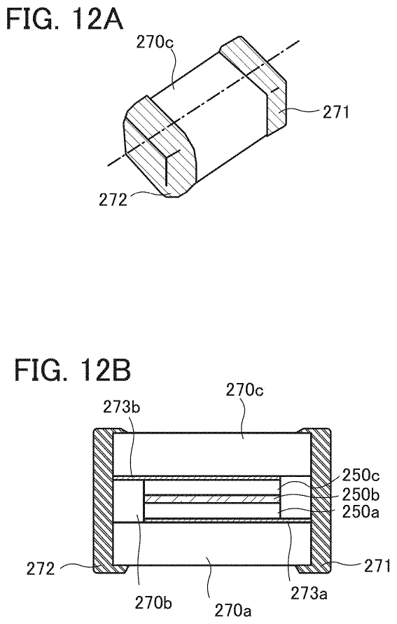

FIG. 12(A) is a perspective view of a secondary battery of one embodiment of the present invention that has an exterior body and a shape different from those in FIG. 11. The secondary battery in FIG. 12(A) includes external electrodes 271 and 272 and is sealed with an exterior body including a plurality of package components.

FIG. 12(B) illustrates an example of a cross section along the dashed-dotted line in FIG. 12(A). A stacked body including the positive electrode 250a, the solid electrolyte layer 250b, and the negative electrode 250c is surrounded and sealed by a package component 270a in which an electrode layer 273a is provided on a flat plate, a frame-like package component 270b, and a package component 270c in which an electrode layer 273b is provided on a flat plate. For the package components 270a, 270b, and 270c, an insulating material such as a resin material or ceramic can be used.

The external electrode 271 is electrically connected to the positive electrode 250a through the electrode layer 273a and functions as a positive electrode terminal. The external electrode 272 is electrically connected to the negative electrode 250c through the electrode layer 273b and functions as a negative electrode terminal.

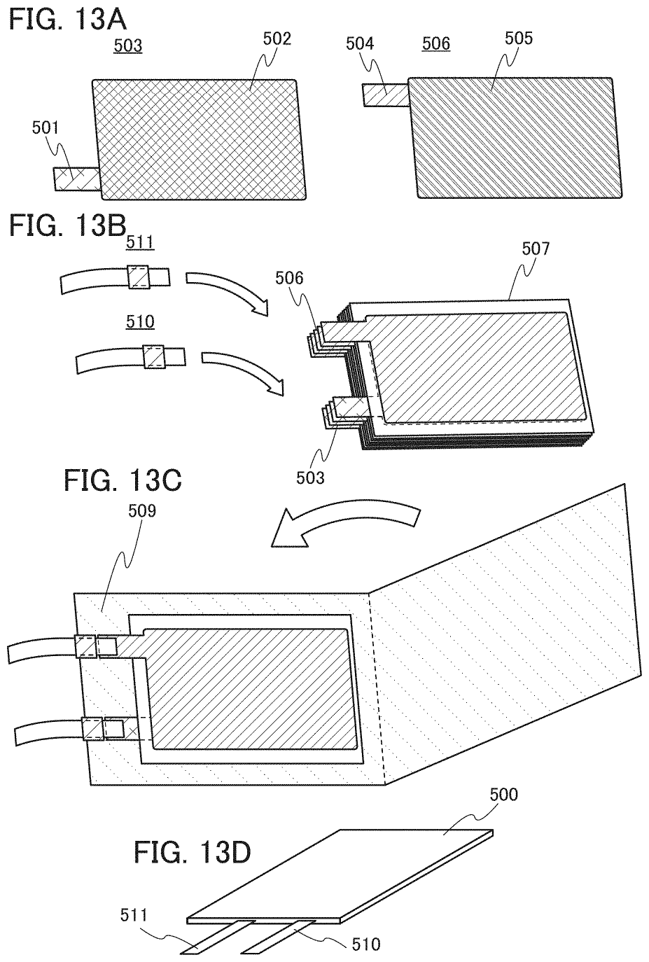

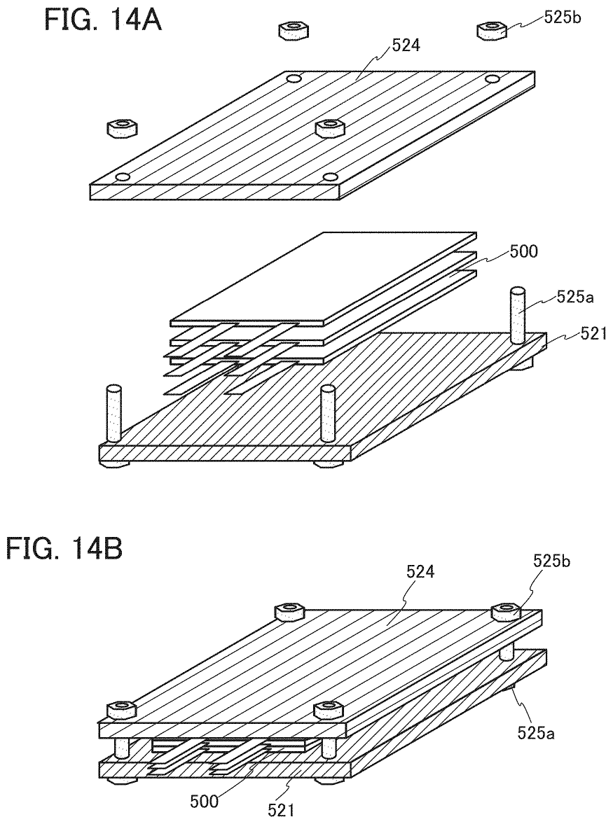

FIG. 13 and FIG. 14 illustrate a laminated secondary battery of one embodiment of the present invention, which is different from the above, and its manufacturing example.

FIG. 13(A) illustrates external views of a positive electrode 503 and a negative electrode 506. The positive electrode 503 includes a positive electrode current collector 501, and a positive electrode active material layer 502 is formed on a surface of the positive electrode current collector 501. In addition, the positive electrode 503 includes, at an end portion, a region where the positive electrode current collector 501 is partly exposed (hereinafter, such a region is referred to as a tab region). The negative electrode 506 includes a negative electrode current collector 504, and a negative electrode active material layer 505 is formed on a surface of the negative electrode current collector 504. In addition, the negative electrode 506 includes, at an end portion, a region where the negative electrode current collector 504 is partly exposed, that is, a tab region. Note that the areas and shapes of the tab regions included in the positive electrode 503 and the negative electrode 506 are not limited to those illustrated in FIG. 13(A).

Then, the negative electrode 506, a solid electrolyte layer 507, and the positive electrode 503 are stacked. FIG. 13(B) illustrates the negative electrodes 506, the solid electrolyte layers 507, and the positive electrodes 503 that are stacked. An example of using five sets of negative electrodes and four sets of positive electrodes is described here. Next, the tab regions of the positive electrodes 503 are bonded to each other, and a positive electrode lead electrode 510 is bonded to the tab region of the outermost positive electrode. Ultrasonic welding or the like may be used for the bonding, for example. In a similar manner, the tab regions of the negative electrodes 506 are bonded to each other, and a negative electrode lead electrode 511 is bonded to the tab region of the outermost negative electrode.

Next, as illustrated in FIG. 13(C), the stacked body of the negative electrodes 506, the solid electrolyte layers 507, and the positive electrodes 503 is positioned over an exterior body 509, and the exterior body 509 is folded along a dashed line. Then, the outer edges of the exterior body 509 are bonded. For the exterior body 509, a laminated film in which metal foil such as aluminum foil or stainless steel foil and an organic resin film are stacked is used, for example. For the bonding, thermocompression bonding is performed, for example. In this manner, a laminated secondary battery 500 illustrated in FIG. 13(D) can be manufactured. Although an example in which one laminated film is used for the bonding is described, two laminated films may be stacked and sealed with the outer edges thereof attached with each other.

A battery module including a plurality of laminated secondary batteries 500 can be mounted on an electric vehicle or the like.

FIG. 14(A) is a perspective view showing three laminated secondary batteries 500 sandwiched and fixed between a first plate 521 and a second plate 524. The distance between the first plate 521 and the second plate 524 is fixed using a fixation tool 525a and a fixation tool 525b as illustrated in FIG. 14(B), whereby stress can be applied to the three secondary batteries 500.

Although FIG. 14(A) and FIG. 14(B) illustrate an example of using the three laminated secondary batteries 500, the number of secondary batteries 500 is not particularly limited and four or more secondary batteries 500 can be used. A set of ten or more secondary batteries 500 can be used as a power source for a compact vehicle, and a set of 100 or more secondary batteries 500 can be used as an in-vehicle large power source. In order to prevent overcharge, the laminated secondary battery 500 may be provided with a protection circuit or a temperature sensor for monitoring the temperature rise.

In an all-solid-state battery, the contact state of the inside interfaces can be kept favorable by applying a predetermined pressure in the direction of stacking positive electrodes and negative electrodes. By applying a predetermined pressure in the direction of stacking positive electrodes and negative electrodes, expansion in the stacking direction due to charging and discharging of the all-solid-state battery can be suppressed, and the reliability of the all-solid-state battery can be improved.

This embodiment can be implemented in appropriate combination with any of the other embodiments.

### Embodiment 3

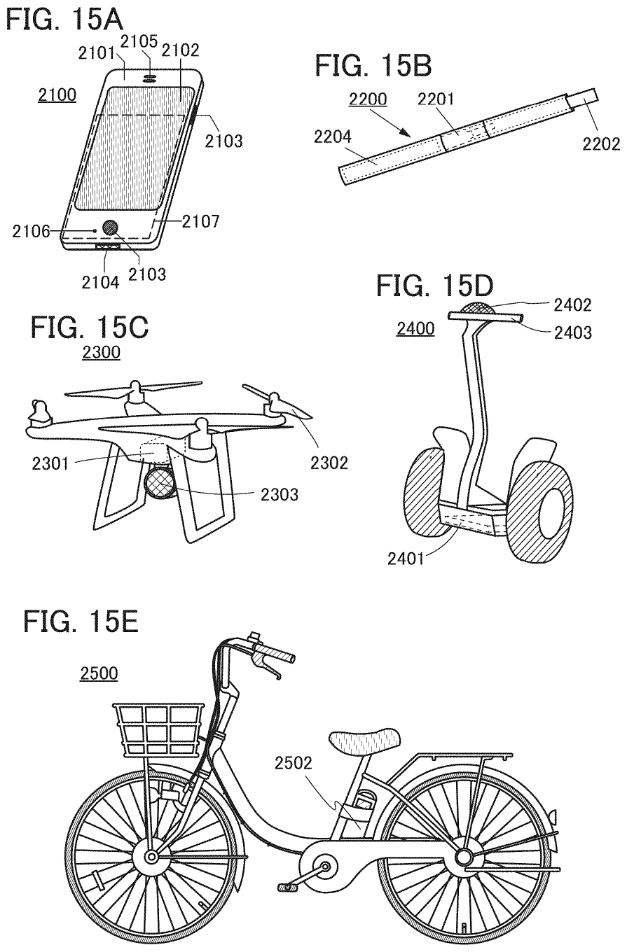

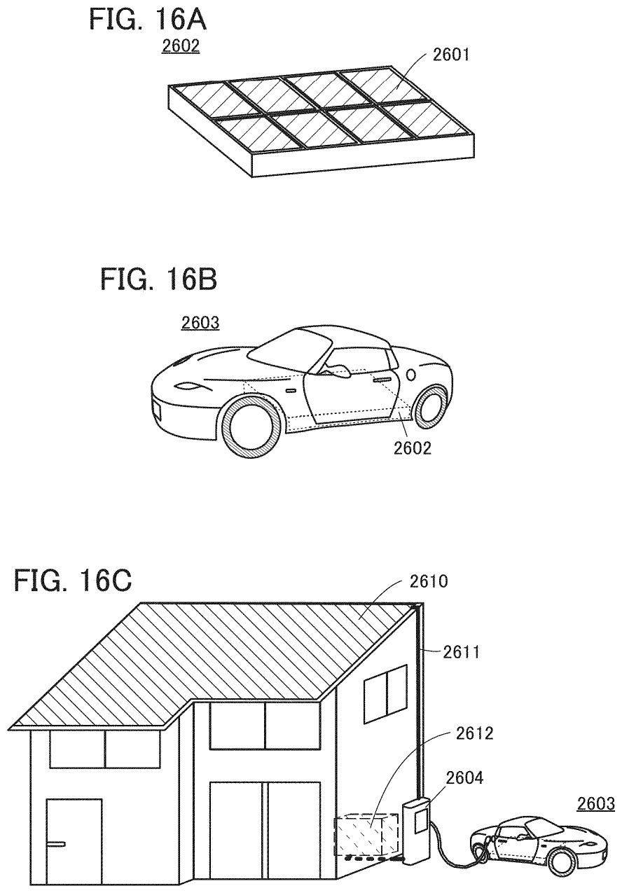

In this embodiment, examples of electronic devices each including the secondary battery described in the above embodiments will be described with reference to FIGS. 15 and FIG. 16.

### [Small Electronic Devices]

First, examples of small electronic devices each including the all-solid-state secondary battery of one embodiment of the present invention will be described with reference to FIG. 15(A) to FIG. 15(C).

FIG. 15(A) illustrates an example of a mobile phone. A mobile phone 2100 includes a housing 2101 in which a display portion 2102 is incorporated, an operation button 2103, an external connection port 2104, a speaker 2105, a microphone 2106, and the like. Note that the mobile phone 2100 includes a secondary battery 2107. With the use of the all-solid-state secondary battery of one embodiment of the present invention as the secondary battery 2107, a lightweight mobile phone with a high level of safety and a long lifetime can be provided.

The mobile phone 2100 is capable of executing a variety of applications such as mobile phone calls, e-mailing, viewing and editing texts, music reproduction, Internet communication, and computer games.

With the operation button 2103, a variety of functions such as time setting, power on/off operation, wireless communication on/off operation, execution and cancellation of a silent mode, and execution and cancellation of a power saving mode can be performed. For example, the functions of the operation button 2103 can also be set freely by an operating system incorporated in the mobile phone 2100.

In addition, the mobile phone 2100 can execute near field communication conformable to a communication standard. For example, hands-free calling is possible by mutual communication between the mobile phone 2100 and a headset capable of wireless communication.

Moreover, the mobile phone 2100 includes the external connection port 2104, and data can be directly transmitted to and received from another information terminal via a connector. In addition, charging can be performed via the external connection port 2104. Note that the charging operation may be performed by wireless power feeding without using the external connection port 2104.

The mobile phone 2100 preferably includes a sensor. As the sensor, for example, a human body sensor such as a fingerprint sensor, a pulse sensor, or a temperature sensor, a touch sensor, a pressure sensor, an acceleration sensor, or the like is preferably mounted.

FIG. 15(B) is a perspective view of a device called a cigarette smoking device (electronic cigarette). In FIG. 15(B), an electronic cigarette 2200 includes a heating element 2201 and a secondary battery 2204 that supplies electric power to the heating element 2201. A stick 2202 is inserted into this, and the stick 2202 is heated by the heating element 2201. To increase safety, a protection circuit for preventing overcharge and overdischarge of the secondary battery 2204 may be electrically connected to the secondary battery 2204. The secondary battery 2204 illustrated in FIG. 15(B) includes an external terminal for connection to a charger. The secondary battery 2204 is a tip portion when the electronic cigarette 2200 is held; thus, it is desirable that the secondary battery 2204 have a short total length and be lightweight. Since the all-solid-state secondary battery of one embodiment of the present invention has a high level of safety, high capacity, and excellent cycle performance, the small and lightweight electronic cigarette 2200 that can be used for a long time over a long period can be provided.

FIG. 15(C) illustrates an unmanned aircraft 2300 including a plurality of rotors 2302. The unmanned aircraft 2300 includes a secondary battery 2301 of one embodiment of the present invention, a camera 2303, and an antenna (not illustrated). The unmanned aircraft 2300 can be remotely controlled through the antenna. The all-solid-state secondary battery of one embodiment of the present invention has a high level of safety, high capacity, and excellent cycle performance, and thus is suitable for the all-solid-state secondary battery mounted on the unmanned aircraft 2300.

### [Vehicles]

Next, examples of vehicles each including the secondary battery of one embodiment of the present invention will be described with reference to FIG. 15(D), FIG. 15(E), and FIG. 16.

FIG. 15(D) illustrates an electric two-wheeled vehicle 2400 using the all-solid-state secondary battery of one embodiment of the present invention. The electric two-wheeled vehicle 2400 includes a secondary battery 2401 of one embodiment of the present invention, a display portion 2402, and a handle 2403. The secondary battery 2401 can supply electricity to a motor serving as a power source. The display portion 2402 can display the remaining battery level of the secondary battery 2401, the velocity and horizontal state of the electric two-wheeled vehicle 2400, and the like.

FIG. 15(E) is an example of an electric bicycle using the secondary battery of one embodiment of the present invention. An electric bicycle 2500 includes a battery pack 2502. The battery pack 2502 includes the all-solid-state secondary battery of one embodiment of the present invention.

The battery pack 2502 can supply electricity to a motor that assists a rider. Furthermore, the battery pack 2502 can be taken off from the bicycle 2500 and carried. The battery pack 2502 and the electric bicycle 2500 may each include a display portion for displaying the remaining battery level and the like.

Furthermore, as illustrated in FIG. 16(A), a secondary battery module 2602 including a plurality of secondary batteries 2601 of one embodiment of the present invention may be mounted on a hybrid electric vehicle (HEV), an electric vehicle (EV), a plug-in hybrid electric vehicle (PHEV), or another electronic device.

FIG. 16(B) illustrates an example of a vehicle including the secondary battery module 2602. A vehicle 2603 is an electric vehicle that runs on the power of an electric motor. Alternatively, the vehicle 2603 is a hybrid electric vehicle capable of selecting as appropriate and using an electric motor and an engine as a power source for driving. The use of one embodiment of the present invention can provide a vehicle with a high level of safety and a wide cruising range.

The secondary battery not only drives the electric motor (not illustrated) but also can supply electric power to a light-emitting device such as a headlight or a room light. Furthermore, the secondary battery can supply electric power to a display device and a semiconductor device included in the vehicle 2603, such as a speedometer, a tachometer, and a navigation system.

In the vehicle 2603, the secondary batteries included in the secondary battery module 2602 can be charged by being supplied with electric power from external charging equipment by a plug-in system, a contactless power feeding system, or the like.

FIG. 16(C) illustrates a state in which the vehicle 2603 is supplied with electric power from ground-based charging equipment 2604 through a cable. In charging, a given method such as CHAdeMO (registered trademark) or Combined Charging System may be employed as a charging method, the standard of a connector, or the like as appropriate. For example, with a plug-in technique, the secondary battery module 2602 incorporated in the vehicle 2603 can be charged by being supplied with electric power from the outside. Charging can be performed by converting AC power into DC power through a converter such as an ACDC converter. The charging equipment 2604 may be provided for a house as illustrated in FIG. 16(C), or may be a charging station provided in a commercial facility.

Furthermore, although not illustrated, with a power receiving device incorporated in the vehicle, the secondary battery module can be charged by being supplied with electric power from an above-ground power transmitting device in a contactless manner. In the case of this contactless power feeding system, by incorporating a power transmitting device in a road or an exterior wall, charging can be performed not only when the vehicle is stopped but also when driven. In addition, this contactless power feeding system may be utilized to transmit and receive electric power between vehicles. Furthermore, a solar cell may be provided in the exterior of the vehicle to charge the secondary battery while the vehicle is stopped or driven. For supply of electric power in such a contactless manner, an electromagnetic induction method or a magnetic resonance method can be used.

The house illustrated in FIG. 16(C) includes a power storage system 2612 including the all-solid-state secondary battery of one embodiment of the present invention and a solar panel 2610. The power storage system 2612 is electrically connected to the solar panel 2610 through a wiring 2611 or the like. The power storage system 2612 may be electrically connected to the ground-based charging equipment 2604. The power storage system 2612 can be charged with electric power generated by the solar panel 2610. The secondary battery module 2602 included in the vehicle 2603 can be charged with the electric power stored in the power storage system 2612 through the charging equipment 2604.

The electric power stored in the power storage system 2612 can also be supplied to other electronic devices in the house. Thus, electronic devices can be used with the use of the power storage system 2612 of one embodiment of the present invention as an uninterruptible power supply even when electric power cannot be supplied from a commercial power supply due to power failure or the like.

This embodiment can be implemented in appropriate combination with any of the other embodiments.

### REFERENCE NUMERALS

100: secondary battery, 110: positive electrode, 111: positive electrode active material, 113: positive electrode current collector, 114: positive electrode active material layer, 120: solid electrolyte layer, 121: solid electrolyte, 130: negative electrode, 131: negative electrode active material, 133: negative electrode current collector, 134: negative electrode active material layer, 140: substrate, 141: wiring electrode, 142: wiring electrode, 250a: positive electrode, 250b: solid electrolyte layer, 250c: negative electrode, 251: electrode plate, 252: insulating tube, 253: electrode plate, 261: lower component, 262: upper component, 264: butterfly nut, 265: O ring, 266: insulator, 270a: package component, 270b: package component, 270c: package component, 271: external electrode, 272: external electrode, 273a: electrode layer, 273b: electrode layer, 500: secondary battery, 501: positive electrode current collector, 502: positive electrode active material layer, 503: positive electrode, 504: negative electrode current collector, 505: negative electrode active material layer, 506: negative electrode, 507: solid electrolyte layer, 509: exterior body, 510: positive electrode lead electrode, 511: negative electrode lead electrode, 521: first plate, 524: second plate, 525a: fixation tool, 525b: fixation tool, 2100: mobile phone, 2101: housing, 2102: display portion, 2103: operation button, 2104: external connection port, 2105: speaker, 2106: microphone, 2107: secondary battery, 2200: electronic cigarette, 2201: heating element, 2202: stick, 2204: secondary battery, 2300: unmanned aircraft, 2301: secondary battery, 2302: rotor, 2303: camera, 2400: electric two-wheeled vehicle, 2401: secondary battery, 2402: display portion, 2403: handle, 2500: bicycle, 2500: electric bicycle, 2502: battery pack, 2601: secondary battery, 2602: secondary battery module, 2603: vehicle, 2604: charging equipment, 2610: solar panel, 2611: wiring, 2612: power storage system.

1. A secondary battery comprising:
a positive electrode active material comprising a composite oxide;
a negative electrode active material;
a first solid electrolyte in contact with the positive electrode active material; and
a second solid electrolyte in contact with the negative electrode active material,
wherein the composite oxide comprises lithium, cobalt, magnesium, oxygen, and fluorine,
wherein the first solid electrolyte is selected from a sulfide-based solid electrolyte, an oxide-based solid electrolyte, and a halide-based solid electrolyte,
wherein the second solid electrolyte is selected from a sulfide-based solid electrolyte, an oxide-based solid electrolyte, and a halide-based solid electrolyte,
wherein the positive electrode active material has a layered rock-salt crystal structure when a depth of charge of the positive electrode active material is less than or equal to 0.06, and
wherein the positive electrode active material has a property that an X-ray diffraction pattern of the positive electrode active material has at least a first peak at 2θ of 19.30±0.20° and a second peak at 2θ of 45.55±0.10°, as analyzed by powder X-ray diffraction with a Cu Kα1 ray when a depth of charge of the positive electrode active material is greater than or equal to 0.77 and less than or equal to 0.84.

2. A secondary battery comprising:
a positive electrode active material comprising a composite oxide;
a negative electrode comprising carbon;
a first solid electrolyte in contact with the positive electrode active material; and
a second solid electrolyte in contact with the negative electrode active material,
wherein the composite oxide comprises lithium, cobalt, magnesium, oxygen, and fluorine,
wherein the first solid electrolyte is selected from a sulfide-based solid electrolyte, an oxide-based solid electrolyte, and a halide-based solid electrolyte,
wherein the second solid electrolyte is selected from a sulfide-based solid electrolyte, an oxide-based solid electrolyte, and a halide-based solid electrolyte,
wherein the positive electrode active material has a layered rock-salt crystal structure in a discharged state, and
wherein the positive electrode active material has a property that an X-ray diffraction pattern of the positive electrode active material has at least a first peak at 2θ of 19.30±0.20° and a second peak at 2θ of 45.55±0.10°, as analyzed by powder X-ray diffraction with a Cu Kα1 ray in a charged state when charged with a lithium metal counter electrode at 25° C. and at a voltage greater than or equal to 4.55V and less than or equal to 4.63V.

3. The secondary battery according to claim 1,
wherein the positive electrode active material comprises a surface portion and inner portion, and
wherein a concentration of magnesium in the surface portion of the positive electrode active material is higher than a concentration of magnesium in the inner portion of the positive electrode active material.

4. The secondary battery according to claim 2,
wherein the positive electrode active material comprises a surface portion and inner portion, and
wherein a concentration of magnesium in the surface portion of the positive electrode active material is higher than a concentration of magnesium in the inner portion of the positive electrode active material.

5. The secondary battery according to claim 1,
wherein the positive electrode active material comprises a surface portion and inner portion,
wherein the surface portion of the positive electrode active material comprises cobalt, magnesium, and oxygen, and
wherein a concentration of cobalt in the surface portion of the positive electrode active material is higher than a concentration of magnesium in the surface portion of the positive electrode active material.

6. The secondary battery according to claim 2,
wherein the positive electrode active material comprises a surface portion and inner portion,
wherein the surface portion of the positive electrode active material comprises cobalt, magnesium, and oxygen, and
wherein a concentration of cobalt in the surface portion of the positive electrode active material is higher than a concentration of magnesium in the surface portion of the positive electrode active material.

7. The secondary battery according to claim 1,
wherein each of the first solid electrolyte and the second solid electrolyte is the oxide-based solid electrolyte,
wherein the oxide-based solid electrolyte comprises a material with a NASICON structure, and
wherein the material comprises lithium, aluminum, titanium, and phosphorus.

8. The secondary battery according to claim 2,
wherein each of the first solid electrolyte and the second solid electrolyte is the oxide-based solid electrolyte,
wherein the oxide-based solid electrolyte comprises a material with a NASICON structure, and
wherein the material comprises lithium, aluminum, titanium, and phosphorus.
